(19) United States
(12) Patent Application Publication
(10) Pub. No.: US 2024/0372150 A1
(43) Pub. Date: Nov. 7, 2024

(54) Methods For Stabilizing A Garnet-Electron Pair Donor Hybrid Electrolyte For A Lithium-Sulfur Battery

(71) Applicants: THE REGENTS OF THE UNIVERSITY OF MICHIGAN, Ann Arbor, MI (US); THE UNIVERSITY OF WATERLOO, Waterloo (CA)

(72) Inventors: JEFFREY SAKAMOTO, Ann Arbor, MI (US); MAX PALMER, Ann Arbor, MI (US); ABHINANDAN SHYAMSUNDER, Waterloo (CA); LINDA NAZAR, Waterloo (CA)

(21) Appl. No.: 18/653,177

(22) Filed: May 2, 2024

Related U.S. Application Data
(60) Provisional application No. 63/463,417, filed on May 2, 2023.

(51) Int. Cl. H01M 10/0569; H01M 4/02; H01M 4/38; H01M 4/62; H01M 10/0562; H01M 10/0568; H01M 50/414; H01M 50/44; H01M 50/491

(52) U.S. Cl. CPC H01M 10/0569; H01M 4/382; H01M 4/625; H01M 10/0562; H01M 10/0568; H01M 50/414; H01M 50/44; H01M 50/491; H01M 2004/027; H01M 2004/028; H01M 2300/0037; H01M 2300/0077

(57) ABSTRACT

A hybrid electrolyte comprises: (i) a first electrolyte having a first surface and an opposed second surface, wherein the first electrolyte comprises a solid state electrolyte material comprising an oxide, wherein the first surface is an acid-treated surface; and (ii) a second electrolyte comprising a liquid electrolyte, wherein the liquid electrolyte comprises an alkali metal salt and a solvent selected from the group consisting of electron pair donor solvents, and solvent mixtures including at least one electron pair donor solvent and at least one glyme solvent. The oxide can be a doped or undoped LLZO electrolyte material, and the acid can be selected from H₃PO₄ and HCl.

### CROSS-REFERENCES TO RELATED APPLICATIONS

This application is based on, claims benefit of, and claims priority to U.S. Application No. 63/463,417 filed on May 2, 2023, which is hereby incorporated by reference herein in its entirety for all purposes.

### STATEMENT REGARDING FEDERALLY SPONSORED RESEARCH

This invention was made with government support under DE-EE 0008855 awarded by the Department of Energy. The government has certain rights in the invention.

### FIELD OF THE INVENTION

This invention relates to electrochemical devices, such as lithium-sulfur batteries, and hybrid electrolytes that can be used in a lithium-sulfur battery.

### BACKGROUND

Lithium-sulfur (Li-S) batteries are a promising next generation battery technology. With sulfur's high discharge capacity of 1,672 mAh/g coupled with a lithium metal anode, the battery has a significant theoretical energy density. Beyond the fact that Li-S offers significantly higher energy density than lithium-ion batteries, their benefits extend to better safety and lower cost. However, in a conventional Li-S battery with a liquid electrolyte, the battery suffers from unstable Li metal cycling and is plagued from the “polysulfide shuttle effect.” During the discharge process of sulfur, lithium polysulfide compounds form, solubilize in the electrolyte, and shuttle between electrodes leading to parasitic reactions, irrecoverable capacity loss, low Coulombic efficiency, and impedance growth. In an all-solid-state configuration with a solid electrolyte (SE), this polysulfide shuttle does not occur although forming good solid-solid contact at the cathode/solid electrolyte interface remains a challenge with resulting high impedances and sluggish kinetics. The addition of a liquid electrolyte (LE) at the solid electrolyte/cathode interface can simultaneously improve contact and ionic transport while the solid electrolyte acts as a physical barrier to protect the Li metal and isolate polysulfides to the cathode.

Electron pair donor (EPD) solvents represent a different class of solvents with large implications in the Li-S battery field. The pioneering work by Cuisinier et al. [Ref. 1.21] showed EPDs highly solvate polysulfide species and can deliver 24% more capacity than conventional glyme electrolytes with near full utilization of sulfur (1,575 mAh/g versus 1,300 mAh/g). This capacity increase is due to the S₃·⁻ radical stabilized in EPDs that acts as a redox mediator for further sulfur discharge. Unfortunately, EPD solvents are not stable with lithium. Li-S battery cells based on EPD solvents have low Coulombic efficiency and quickly short [Ref. 1.21].

Therefore, what is needed are compositions and methods for the formation of a stable solid electrolyte/liquid electrolyte interface for the successful implementation of hybrid electrolyte schemes to enable lithium-sulfur batteries.

### SUMMARY OF THE INVENTION

The present disclosure meets the forgoing needs by providing hybrid electrolytes and methods for stabilizing an electron pair donor liquid electrolyte solvent and a solid state electrolyte in a lithium-sulfur battery.

In one aspect, this disclosure provides a hybrid electrolyte for an electrochemical device. The hybrid electrolyte comprises: (i) a first electrolyte having a first surface and an opposed second surface, wherein the first electrolyte comprises a solid state electrolyte material comprising an oxide, wherein the first surface is an acid-treated surface; and (ii) a second electrolyte comprising a liquid electrolyte, wherein the liquid electrolyte comprises an alkali metal salt and a solvent selected from the group consisting of electron pair donor solvents, and solvent mixtures including at least one electron pair donor solvent and at least one glyme solvent.

In one embodiment of the hybrid electrolyte, the solvent comprises an electron pair donor solvent having a donor number (DN) greater than 15 kcal/mol. In one embodiment of the hybrid electrolyte, the solvent comprises an electron pair donor solvent having a donor number (DN) greater than 20 kcal/mol. In one embodiment of the hybrid electrolyte, the solvent comprises an electron pair donor solvent having a donor number (DN) greater than 25 kcal/mol. In one embodiment of the hybrid electrolyte, the solvent comprises N,N-dimethylacetamide (DMA). In one embodiment of the hybrid electrolyte, the solvent comprises a solvent mixture including at least one electron pair donor solvent and at least one glyme solvent. In one embodiment of the hybrid electrolyte, the solvent comprises a solvent mixture including 1,3-dioxolane (DOL) and 1,2-dimethoxyethane (DME).

In one embodiment of the hybrid electrolyte, the alkali metal salt is selected from the group consisting of lithium (halosulfonyl)imides, lithium (haloalkanesulfonyl)imides, lithium (halosulfonyl haloalkanesulfonyl)imides, and mixtures thereof. In one embodiment of the hybrid electrolyte, the alkali metal salt is selected from the group consisting of LiBF₄, LiClO₄, LiCF₃SO₃ (LiTf), lithium bis(fluorosulfonyl)imide (LiFSI), lithium bis(trifluoromethanesulfonyl)imide (LiTFSI), lithium (fluorosulfonyl trifluoromethanesulfonyl)imide (LiFTFSI), lithium bis(pentafluoroethanesulfonyl)imide (LiBETI), and mixtures thereof. In one embodiment of the hybrid electrolyte, the salt is lithium bis(trifluoromethanesulfonyl)imide (LiTFSI).

In one embodiment of the hybrid electrolyte, the second electrolyte contacts the first surface of the first electrolyte. In one embodiment of the hybrid electrolyte, the second electrolyte is impregnated in a porous separator layer. In one embodiment of the hybrid electrolyte, the separator layer comprises a matrix comprising inorganic fibers. In one embodiment of the hybrid electrolyte, the separator layer comprises a polymeric material. In one embodiment of the hybrid electrolyte, a gasket is arranged adjacent a perimeter of the separator layer to contain the second electrolyte in the separator layer. In one embodiment of the hybrid electrolyte, the solid state electrolyte material is densified through conventional sintering or hot pressed.

In one embodiment of the hybrid electrolyte, the first surface of the first electrolyte is acid-treated using a mineral acid to remove surface impurities. In one embodiment of the hybrid electrolyte, the mineral acid is selected from the group consisting of H₃PO₄, HCl, HNO₃, H₂SO₄, and mixtures thereof. In one embodiment of the hybrid electrolyte, the mineral acid is H₃PO₄. In one embodiment of the hybrid electrolyte, the mineral acid is HCl.

In one embodiment of the hybrid electrolyte, the solid state electrolyte material has a garnet phase.

In one embodiment of the hybrid electrolyte, an interfacial resistance of an interface of the first electrolyte and the second electrolyte is 100 Ωcm² or less. In one embodiment of the hybrid electrolyte, an interfacial resistance of an interface of the first electrolyte and the second electrolyte is 50 Ωcm² or less.

In one embodiment of the hybrid electrolyte, the solid state electrolyte material has the formula LiᵤReᵥMₓAₓO_{y}, wherein
Re can be any combination of elements with a nominal valance of +3 including La, Nd, Pr, Pm, Sm, Sc, Eu, Gd, Tb, Dy, Y, Ho, Er, Tm, Yb, and Lu;
M can be any combination of metals with a nominal valance of +3, +4, +5 or +6 including Zr, Ta, Nb, Sb, W, Hf, Sn, Ti, V, Bi, Ge, and Si;
A can be any combination of dopant atoms with nominal valance of +1, +2, +3 or +4 including H, Na, K, Rb, Cs, Ba, Sr, Ca, Mg, Fe, Co, Ni, Cu, Zn, Ga, Al, B, and Mn;
u can vary from 3-7.5;
v can vary from 0-3;
w can vary from 0-2;
x can vary from 0-2; and y can vary from 11-12.5.

In one embodiment of the hybrid electrolyte, the solid state electrolyte material is Li_{6.5}La₃Zr_{1.5}Ta_{0.5}O₁₂ (LLZTO). In one embodiment of the hybrid electrolyte, the solid state electrolyte material is Li₇La₃Zr₂O₁₂ (LLZO).

In one embodiment of the hybrid electrolyte, the first surface of the first electrolyte is acid-treated using H₃PO₄.

In one embodiment of the hybrid electrolyte, the first surface of the first electrolyte includes phosphate groups. In one embodiment of the hybrid electrolyte, the first surface of the first electrolyte includes Li₃PO₄. In one embodiment of the hybrid electrolyte, the first surface of the first electrolyte includes a phosphorylated layer. In one embodiment of the hybrid electrolyte, the phosphorylated layer has a thickness in a range of 1-30 nanometers.

In another aspect, this disclosure provides an electrochemical device comprising: a hybrid electrolyte of any embodiment of the present disclosure; a cathode facing the first surface of the first electrolyte of the hybrid electrolyte; an anode contacting the second surface of the first electrolyte of the hybrid electrolyte, wherein the anode comprises lithium metal. The cathode may comprise a cathode active material selected from sulfur containing materials. The cathode may comprise S₈. In one embodiment of the electrochemical device, the cathode comprises 60-80 wt. % S₈ and 20-40 wt. % of a carbon conductive additive based on total weight of the cathode.

In one embodiment of the electrochemical device, a discharge capacity of the electrochemical device is greater than 70% of theoretical discharge capacity at a tenth cycle. In one embodiment of the electrochemical device, a discharge capacity of the electrochemical device is greater than 80% of theoretical discharge capacity at a tenth cycle. In one embodiment of the electrochemical device, the solvent comprises an electron pair donor solvent. In one embodiment of the electrochemical device, the solvent comprises N,N-dimethylacetamide (DMA).

In one embodiment of the electrochemical device, a total interfacial resistance of a first interface of the first electrolyte and the second electrolyte and a second interface of the first electrolyte and the anode is 100 Ωcm² or less. In one embodiment of the electrochemical device, a total interfacial resistance of a first interface of the first electrolyte and the second electrolyte and a second interface of the first electrolyte and the anode is 50 Ωcm² or less.

In yet another aspect, this disclosure provides a method for stabilizing an electron pair donor liquid electrolyte solvent and a solid state doped or undoped LLZO electrolyte having a first surface and an opposed second surface in a lithium-sulfur battery having a sulfur-containing cathode facing the first surface of the LLZO electrolyte and a lithium metal anode contacting the second surface of the LLZO electrolyte. The method can comprise treating the first surface of the LLZO electrolyte with an acid before contacting the first surface of the LLZO electrolyte with a liquid electrolyte including a lithium metal salt and the electron pair donor liquid electrolyte solvent. The acid can be selected from the group consisting of H₃PO₄, HCl, HNO₃, H₂SO₄, and mixtures thereof. The acid can be H₃PO₄. The acid can be HCl.

In one embodiment of the method, the electron pair donor liquid electrolyte solvent has a donor number (DN) greater than 15 kcal/mol. In one embodiment of the method, the electron pair donor liquid electrolyte solvent has a donor number (DN) greater than 20 kcal/mol. In one embodiment of the method, the electron pair donor liquid electrolyte solvent has a donor number (DN) greater than 25 kcal/mol. In one embodiment of the method, the electron pair donor liquid electrolyte solvent comprises N,N-dimethylacetamide (DMA).

In one embodiment of the method, the method further comprises including in the liquid electrolyte at least one glyme solvent. In one embodiment of the method, the electron pair donor liquid electrolyte solvent comprises a solvent mixture including 1,3-dioxolane (DOL) and 1,2-dimethoxyethane (DME). In one embodiment of the method, the method further comprises including in the liquid electrolyte 1,2-dimethoxyethane (DME). In one embodiment of the method, the method further comprises impregnating the liquid electrolyte in a porous separator layer. In one embodiment of the method, the method further comprises arranging a gasket adjacent a perimeter of the separator layer to contain the liquid electrolyte in the separator layer.

In one embodiment of the method, an interfacial resistance of an interface of the solid state doped or undoped LLZO electrolyte and the liquid electrolyte is 100 Ωcm² or less. In one embodiment of the method, an interfacial resistance of an interface of the solid state doped or undoped LLZO electrolyte and the liquid electrolyte is 50 Ωcm² or less.

In one embodiment of the method, the treated first surface of the solid state doped or undoped electrolyte includes phosphate groups. In one embodiment of the method, the treated first surface of the solid state doped or undoped electrolyte includes Li₃PO₄. In one embodiment of the method, the treated first surface of the solid state doped or undoped electrolyte includes a phosphorylated layer.

In one embodiment of the method, the phosphorylated layer has a thickness in a range of 1-30 nanometers. In one embodiment of the method, the solid state electrolyte material is Li_{6.5}La₃Zr_{1.5}Ta_{0.5}O₁₂ (LLZTO). In one embodiment of the method, the solid state electrolyte material is Li₇La₃Zr₂O₁₂ (LLZO).

The foregoing and other aspects and advantages of the invention will appear from the following description. In the description, reference is made to the accompanying drawings which form a part hereof, and in which there is shown by way of illustration example embodiments of the invention. Such embodiments do not necessarily represent the full scope of the invention, however, and reference is made therefore to the claims and herein for interpreting the scope of the invention.

### BRIEF DESCRIPTION OF DRAWINGS

FIG. 1 is a schematic of an example embodiment of a lithium-sulfur battery according to the invention.

FIG. 1A shows a schematic of a S/LE/LLZO/LE/S symmetric cell.

FIG. 1B shows a schematic of a S/LE/LLZO/Li full cell.

FIG. 2 shows in panels a),b) Nyquist plot of S/LE/LLZO/LE/S symmetric cells with LE=1 M LiTFSI in DOL:DME and 1 M LiTFSI in DMA; in panel c), fit of HT-LLZO/DOL:DME t=72 hours symmetric cell; and in panel d), postmortem picture of the DMA electrolyte from a HT-LLZO/DMA symmetric cell.

FIG. 3 shows the change in sulfur dissolved in DMA solvent color based on addition of LLZO, Li₂CO₃, and LiOH.

FIG. 4 shows in panel a), evolution of the interfacial impedance between LLZO and DOL:DME after heat treating LLZO versus a hydrochloric acid treatment of LLZO; and in panel b), interfacial impedance evolution between LLZO and DMA after a hydrochloric versus phosphoric acid treatment of LLZO.

FIG. 5 shows in panel a), cycling of a Li-S cell with the HCl-LLZO/DOL:DME dual electrolyte; and in panel b), Nyquist plots showing the cell impedance over the course of cycling.

FIG. 6 shows an overview of Example 2.

FIG. 7 shows in panel (a), schematic of the Swagelok assembly hosting the sulfur symmetric cell used to measure the areal resistance of SE/LE; in panel (b), Nyquist plot of the symmetric cell with the S₈-C electrodes in 1 M LiTFSI/DOL-DME and HT-LLZO after 36 h of continuous storage; in panel (c), equivalent circuit used for EIS fitting; in panel (d), evolution of the Nyquist plot of the symmetric cells with HT-LLZO upon the storage in DOL-DME (light red −0 h, dark red −36 h) and in DMA (light blue −0 h, dark blue −12 h); in panel (e), enlarged Nyquist plot of the symmetric cells in DMA. The coloration of the DMA electrolyte indicates the side reactions between sulfur and LiOH on the surface of LLZO.

FIG. 8 shows in panel (a), UV-vis spectra of the deep burgundy liquid obtained from a HT-LLZO DMA cell (wine trace), blue liquid obtained from diluting the deep burgundy liquid (blue trace) and the DOL-DME electrolyte (black trace); and in panel (b), S 2p spectrum of the HT-LLZO pellet used in the DMA cell (wine trace) and the DOL-DME cell (black trace) along with the spectral deconvolution (see legend).

FIG. 9 shows possible reaction pathways of the trisulfide radical in DMA.

FIG. 10 shows stability of SLEI between LLZO and LE. Panel (a) shows Nyquist plot of the symmetric cells with S₈-C electrodes with HT-LLZO (green −0 hours, cyan −36 hours) and HCl-LLZO (red −0 h, brown −36 hours) with DOL-DME LE, and panel (b) shows change in Rᵢₙₜ upon storage for 36 hours. Panel (c) shows Nyquist plot of the symmetric cells with S₈-C electrodes HCl-LLZO (red −0 hours, brown −36 hours) with DMA LE, and panel (d) shows change in Rᵢₙₜ upon storage for 36 hours. EIS spectra were recorded at an OCV (10 mV amplitude) and 25° C. from 1 MHz to 0.1 Hz. The fitting error of Rᵢₙₜ is below 1 Ωcm² in panel (e) C 1 s and in panel (f) O 1s XPS spectra of HT-LLZO after 10 minutes of Ar-sputtering (bottom panel) and HCl-LLZO (top panel). The fittings of C 1 s and O 1s spectra are shown by the solid lines. The distribution of the O-containing species is shown in brackets.

FIG. 11 shows in panel (a), a Nyquist plot of the symmetric cells after assembly (light violet-HPO-LLZO and light cyan-HCl LLZO) and storage for 36 hours (dark violet-HPO-LLZO and dark cyan-HCl-LLZO); in panel (b), temporal evolution of Rᵢₙₜ of the SLEI between DMA LE and HPO-LLZO (dark violet) and HCl-LLZO (dark cyan). The fitting error of Rᵢₙₜ is below 1 Ωcm²; panel (c) P 2p XPS of HPO-LLZO (dark violet). The fitting of the P 2p spectrum is shown by the P_{1/2}-P_{3/2} doublet (light violet). The photographs of panel (d) HCl-LLZO and panel (e) HPO-LLZO after 1 hour of storage in S₈/DMA suspension.

FIG. 12 shows in panel (a), S 2p XPS spectra of HPO-LLZO (i) before and (ii) after the reaction with the S₈/DMA suspension. The surface of HPO-LLZO remains free of any S-containing species; HCl-LLZO (iii) before and (iv) after the reaction with the S₈/DMA suspension. The 2p_{1/2} and 2p_{3/2} peaks of the formed products indicate polythionate (red), thiosulfate (blue), and sulfide (gold). In Panel (b), La 3d XPS spectra of HPO-LLZO (i) before and (ii) after the reaction of S₈/DMA suspension and HCl-LLZO (iii) before and (iv) after the reaction with S₈/DMA. The blue lines represent the 3d_{3/2} and 3d_{5/2} split doublets of La³⁺ in the pristine LLZO (La-LLZO). LaPO₄ detected at the surface of HPO-LLZO (i, ii) is shown in purple. The red solid lines (iii) show the La-S species (HCl-LLZO) formed upon storage in a S₈/DMA suspension.

FIG. 13 shows electrochemical performance of Li∥S₈-C cells. Panel (a) shows 1st and 5th cycles of the cells with HCl-LLZO (green) and HPO-LLZO (violet) in a 1 M LiTFSI/DMA electrolyte. Panel (b) shows capacity as a function of cycle number for Li-S cells with HCl-LLZO (green) and HPO-LLZO (violet) in a 1 M LiTFSI/DMA electrolyte. La 3d panel (c), P 2p panel (d), and S 2p panel (e) XPS spectra of the HPO-LLZO pellet after 5 cycles denoting the resilience of the phosphate coating toward polysulfide species.

FIG. 14 shows a Nyquist plot of a symmetric cell with a S₈-C electrode in 1 M LiTFSI/DOL-DME in the frequency range from panel a) 1 MHz to 0.1 Hz; panel b) the magnified spectrum showing the low contact resistance of 2 Ωcm² between S₈ and C.

FIG. 15 shows the transmission line model used to fit the low-frequency tail of the symmetric cells with C/S₈ electrodes.

FIG. 16 shows the temporal evolution of Rᵢₙₜ of the symmetric cells with C-S₈ electrodes with HT-LLZO and DMA.

FIG. 17 shows an EDX spectrum of the solid remaining after solvent evaporation from the deep-red liquid showing atomic contributions from only C, O and S but no La, Zr or Ta.

FIG. 18 shows a UV-Vis spectrum with photographs of the colored solutions obtained by reacting panel a) LiOH with S and DMA and panel b) Li₂CO₃ with S and DMA.

FIG. 19 shows a ¹H NMR spectrum of pure DMA, red liquid obtained from DMA+S+LiOH and DMA+S+LLZO in panel a and that of pure DMSO, red liquid obtained from DMSO+S+LiOH and DMSO+S+LLZO in panel b. The expanded regions between δ=3.75 and 3.9 ppm indicate the presence of higher order hydrogen polysulfides.

FIG. 20 shows in panel a, the effect of sputtering time on the P 2p spectrum of HPO-LLZO. The intensity of each signal was normalized to its maximum and plotted without background subtraction. P-containing products are almost completely removed after 10 minutes of Ar⁺ sputtering. In panel b, there is shown the integral intensity of the P 2p peak at different sputtering times, normalized to intensity of the sputtered sample.

FIG. 21 shows a La 3d XPS of HT-LLZO after 10 minutes of sputtering with Ar⁺ plasma. The main (f⁰) and the satellite (f¹) peaks are separated by 16.8 eV due to spin-orbit coupling. The separation between the 3d_{3/2} and 3d_{5/2} peaks caused by charge compensation is 4.2 eV. These energy values match the previously reported ones.

FIG. 22 shows an XPS of HPO-LLZO before and after 1 and 10 minutes of sputtering with Ar-plasma showing the panel a) Zr 3d and panel b) La 3d regions. The surface concentration of La and Zr phosphates is ˜40% but it is reduced with depth of sputtering to ˜10% for LaPO₄ and completely vanishes for Zr.

FIG. 23 shows a Zr 3d XPS of HCl-LLZO before (bottom panel) and after (top panel) the reaction with S₈/DMA suspension. The unchanged position of the spin doublet of Zr (blue lines) indicates its compatibility with lithium polysulfides.

FIG. 24 shows in panel a), galvanostatic cycling of HCl-LLZO/DOL-DME at 0.1 mA/cm² and in panel b), the charge and discharge capacity of the cell for each cycle. The lack of overcharge upon cycling demonstrates LLZO completely inhibits the polysulfide shuttle.

The invention will be better understood and features, aspects and advantages other than those set forth above will become apparent when consideration is given to the following detailed description thereof. Such detailed description makes reference to the drawings.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown, but are to be accorded the widest scope consistent with the principles and features disclosed herein. Skilled artisans will recognize the examples provided herein have many useful alternatives and fall within the scope of embodiments of the invention.

Although the systems and methods introduced herein are often described for use in an electrochemical cell or battery, one of skill in the art will appreciate that these teachings can be used for various applications (e.g. sensors, fuel cells).

This disclosure relates to designing a platform to stabilize and implement a garnet-electron pair donor hybrid (e.g., dual) electrolyte lithium-sulfur battery. In order to test the lithium-sulfur battery, this platform uses a perfluoro elastomer gasket to hermetically seal the lithium to protect it from the electron pair donor electrolyte and sulfur compounds. This gasket is an elastomer that: (1) is stable and does not solvent swell against liquid electrolytes used in lithium-sulfur batteries; and (2) does not interfere with the cathode/electrolyte interface. Furthermore, to stabilize the garnet-electron pair donor interactions in the presence of sulfur, this platform uses in one embodiment a phosphoric acid and ethanol wash of the garnet solid state electrolyte. This acid treatment removes garnet surfaces contaminations and forms a lithium phosphate protective film.

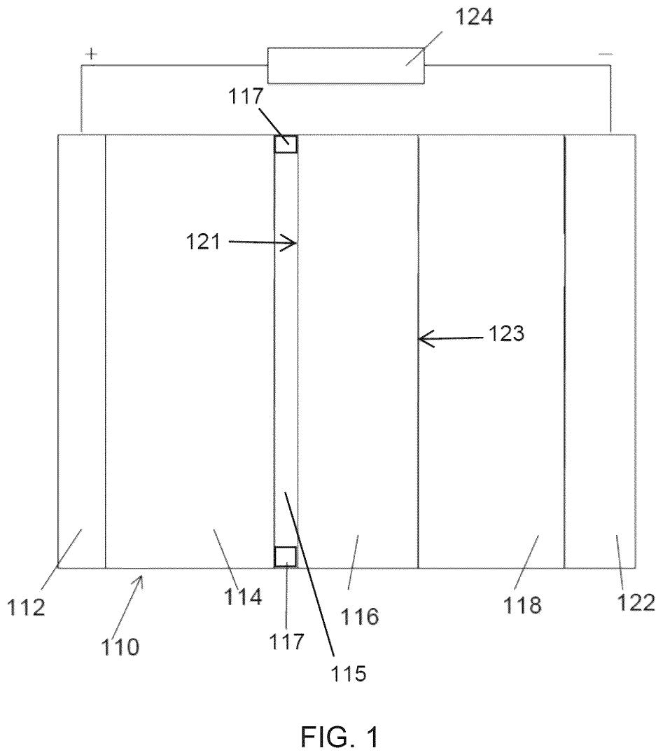

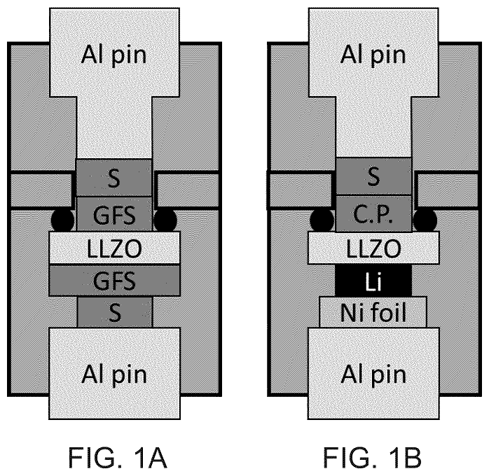

In one non-limiting example application, a hybrid electrolyte of the present disclosure can be used in a lithium-sulfur battery 110 as depicted in FIG. 1. The lithium-sulfur battery 110 includes a current collector 112 (e.g., aluminum) in contact with a cathode 114. The solid-state electrolyte 116 is arranged between the cathode 114 and an anode 118, which is in contact with a current collector 122 (e.g., copper). The solid-state electrolyte 116 has a first surface 121 and an opposite second surface 123. The current collectors 112 and 122 of the lithium metal battery 110 may be in electrical communication with an electrical component 124. The electrical component 124 could place the lithium-sulfur battery 110 in electrical communication with an electrical load that discharges the battery or a charger that charges the battery. Optionally, a separator layer 115 may be positioned between the solid-state electrolyte 116 and the cathode 114. A gasket 117 can be arranged at the perimeter of the separator layer 115 to contain liquid electrolyte in the separator layer 115.

The hybrid electrolyte of the battery 110 can comprise the solid-state electrolyte 116 and a liquid electrolyte. The liquid electrolyte may comprise a lithium salt in an organic solvent. The lithium salt may be selected from LiBF₄, LiClO₄, LiCF₃SO₃ (LiTf), lithium bis(fluorosulfonyl)imide (LiFSI), lithium bis(trifluoromethanesulfonyl)imide (LiTFSI), lithium (fluorosulfonyl trifluoromethanesulfonyl)imide (LiFTFSI),and lithium bis(pentafluoroethanesulfonyl)imide (LiBETI). The organic solvent may be selected from electron pair donor (EPD) solvents, glyme solvents (i.e., organic ethers with the molecular formula RO[CH₂CH₂O]ₙR, wherein R is an alkyl group and n is an integer), and mixtures thereof. Non-limiting example EPD solvents include N,N-dimethylacetamide (DMA), 1,3-dioxolane (DOL), dimethylsulfoxide (DMSO), and N,N-dimethylformamide (DMF). In one embodiment, the EPD solvent has a donor number (DN) of at least 15 kcal/mol, or at least 20 kcal/mol, or at least 25 kcal/mol. Non-limiting example glyme solvents include 1,2-dimethoxyethane (DME) (monoglyme) (wherein R is methyl and n=1), diglyme (R=methyl, n=2), triglyme (R=methyl, n=3), tetraglyme (R=methyl, n=4), ethyl glyme (R=ethyl, n=1), ethyl diglyme (R=ethyl, n=2), butyl glyme (R=butyl, n=1), and butyl diglyme (R=butyl, n=2).

In one embodiment, the hybrid electrolyte has an interfacial resistance of an interface of the first electrolyte and the second electrolyte of 100 Ωcm² or less. In one embodiment, the hybrid electrolyte has an interfacial resistance of an interface of the first electrolyte and the second electrolyte of 50 Ωcm² or less. In one embodiment, the hybrid electrolyte has an interfacial resistance of an interface of the first electrolyte and the second electrolyte of 30 Ωcm² or less.

In some embodiments, the solid state electrolyte 116 can comprise a solid state electrolyte material having the formula LiᵤReᵥM_{w}AₓO_{y}, wherein
Re can be any combination of elements with a nominal valance of +3 including La, Nd, Pr, Pm, Sm, Sc, Eu, Gd, Tb, Dy, Y, Ho, Er, Tm, Yb, and Lu;
M can be any combination of metals with a nominal valance of +3, +4, +5 or +6 including Zr, Ta, Nb, Sb, W, Hf, Sn, Ti, V, Bi, Ge, and Si;
A can be any combination of dopant atoms with nominal valance of +1, +2, +3 or +4 including H, Na, K, Rb, Cs, Ba, Sr, Ca, Mg, Fe, Co, Ni, Cu, Zn, Ga, Al, B, and Mn;
u can vary from 3-7.5;
v can vary from 0-3;
w can vary from 0-2;
x can vary from 0-2; and
y can vary from 11-12.5.
   The solid state electrolyte material can have the garnet phase. Li_{6.5}La₃Zr_{1.5}Ta_{0.5}O₁₂ (LLZTO) is one non-limiting example solid state electrolyte material. Li₇La₃Zr₂O₁₂ (LLZO) is another non-limiting example solid state electrolyte material.

The solid-state electrolyte 116 may be formed by (a) casting a slurry of a solid-state electrolyte material on a surface to form a layer; and (b) sintering the layer to form the solid-state electrolyte. In this method, the layer may be sintered at a temperature in a range of 600° C. to 1250° C. to achieve the necessary electrochemical properties. The layer can have a thickness in a range of 10 to 200 microns. The solid state electrolyte material can also be heat-treated under inert atmosphere to remove surface impurities. The solid state electrolyte material can be heat-treated in a temperature range of 350° C. to 700° C., or in a temperature range of 375° C. to 425° C.

The solid-state electrolyte 116 may alternatively be formed by a hot pressing technique comprising combining dry powders having the desired cations for the final solid-state electrolyte to form a mixture; cold-pressing and calcining the mixed dry powders at temperatures between 500-1000 degrees Celsius for 2-8 hours; and applying simultaneous heat and pressure to the mixture to form the solid-state electrolyte. The hot-pressing technique may use at least one of induction heating, indirect resistance heating, or direct hot-pressing. Heat can be applied at a temperature at or below 1250 degrees Celsius. Pressure can be applied at between 5 and 80 MPa. The solid state electrolyte material can also be heat-treated under inert atmosphere to remove surface impurities. The solid state electrolyte material can be heat-treated in a temperature range of 350° C. to 700° C., or in a temperature range of 375° C. to 425° C.

The first surface 123 of the formed solid-state electrolyte 116 can be acid-treated using a mineral acid to remove surface impurities. The mineral acid can be selected from the group consisting of H₃PO₄, HCl, HNO₃, H₂SO₄, and mixtures thereof. The mineral acid can be H₃PO₄. The mineral acid can be HCl.

A suitable material for the cathode 114 of the lithium-sulfur battery 110 is a sulfur containing material. The cathode 114 may include some form of solid elemental sulfur, including crystalline sulfur, amorphous sulfur, precipitated sulfur, and sulfur solidified from the melt. Elemental sulfur includes the various polyatomic molecules of sulfur, especially the octasulfur allotrope characterized as cyclo-S₈ ring, and polymorphs thereof such as α-octasulfur, β-octasulfur, and γ-octasulfur. For example, elemental sulfur (in the form of sulfur particulates including nano-sized sulfur particles) may be incorporated as a material component of the cathode, wherein, e.g., the sulfur may be admixed with high surface area or activated carbon particles and an appropriate binder (PVDF) for adhering the material components in a suitable liquid carrier for formulating a slurry to be coated onto or impregnated into a porous matrix structure. In some embodiments, the cathode 114 may include a conductive additive such as graphite, carbon black, acetylene black, Ketjen black, channel black, furnace black, lamp black, thermal black, conductive fibers, metallic powders, conductive whiskers, conductive metal oxides, and mixtures thereof. In one embodiment, the cathode 114 may include 50-90 wt. % S₈ and 10-50 wt. % of a carbon conductive additive, or 60-80 wt. % S₈ and 20-40 wt. % of a carbon conductive additive based on total weight of the cathode.

A suitable active material for the anode 118 of the lithium-sulfur battery 110 comprises lithium metal. In other embodiments, an example anode 118 material consists essentially of lithium metal, or consists of lithium metal.

The first current collector 112 and the second current collector 122 can comprise a conductive metal or any suitable conductive material. In some embodiments, the first current collector 112 and the second current collector 122 comprise aluminum, nickel, copper, combinations and alloys thereof. In other embodiments, the first current collector 112 and the second current collector 122 have a thickness of 0.1 microns or greater. It is to be appreciated that the thicknesses depicted in FIG. 1 are not drawn to scale, and that the thickness of the first current collector 112 and the second current collector 122 may be different.

The present invention is not limited to lithium-sulfur batteries with a lithium metal anode. The electrochemical cell may be a lithium-ion cell wherein the anode may comprise a lithium host material selected from the group consisting of graphite, activated carbon, carbon black, lithium titanate, graphene, tin-cobalt alloys, and silicon, and the cathode is a lithium host material capable of storing and subsequently releasing lithium ions. An example cathode active material is a lithium metal oxide wherein the metal is one or more aluminum, cobalt, iron, manganese, nickel and vanadium. Non-limiting example lithium metal oxides are LiCoO₂ (LCO), LiFeO₂, LiMnO₂ (LMO), LiMn₂O₄, LiNiO₂ (LNO), LiNiₓCo_{y}O₂ (x+y=₁), LiMnₓCo_{y}O₂ (x+y=1), Li(NiₓMn_{y})O₄ (x+y=1), LiMnₓNi_{y}O₂ (x+y=1), LiMnₓNi_{y}O₄ (x+y=₁), LiNiₓCo_{y}Al_{z}O₂ (x+y+z=1), LiNi_{1/3}Mn_{1/3}Co_{1/3}O₂ and others. Another example of cathode active materials is a lithium-containing phosphate having a general formula LiMPO₄ wherein M is one or more of cobalt, iron, manganese, and nickel, such as LiFePO₄, LiCoPO₄, Li(CoₓFe_{y}Ni_{z})PO₄ (x+y+z=1), and lithium iron fluorophosphates. Another example of a cathode active material is V₂O₅. Many different elements, e.g., Co, Mn, Ni, Cr, Al, or Li, may be substituted or additionally added into the structure to influence electronic conductivity, ordering of the layer, stability on delithiation and cycling performance of the cathode materials. The cathode active material can be selected from the group consisting of cathode material particles having a formula LiNiₓMn_{y}Co_{z}O₂, wherein x+y+z=1 and x:y:z=1:1:1 (NMC 111), x:y:z=4:3:3 (NMC 433), x:y:z=5:2:2 (NMC 522), x:y:z=5:3:2 (NMC 532), x:y:z=6:2:2 (NMC 622), or x:y:z=8:1:1 (NMC 811). The cathode active material can be a mixture of any number of these cathode active materials.

In alternative embodiments, a suitable anode can comprise sodium in which case a suitable Na ion conducting solid electrolyte is needed. For example, the solid electrolyte could be: sodium-β-alumina, sodium-β″-alumina or the family of compounds refer to NaSICON of nominal formula Na₃Zr₂Si₂PO₁₂.

An electrochemical device of the invention may comprise: a hybrid electrolyte of the present disclosure; a cathode facing the first surface of the first electrolyte of the hybrid electrolyte; an anode contacting the second surface of the first electrolyte of the hybrid electrolyte, wherein the anode comprises lithium metal. The cathode may comprise a cathode active material selected from sulfur containing materials. The cathode may comprises S₈. In the electrochemical device, a total interfacial resistance of a first interface of the first electrolyte and the second electrolyte and a second interface of the first electrolyte and the anode can be 100 Ωcm² or less. In the electrochemical device, a total interfacial resistance of a first interface of the first electrolyte and the second electrolyte and a second interface of the first electrolyte and the anode can be 50 Ωcm² or less. In one embodiment of the electrochemical device, a discharge capacity of the electrochemical device is greater than 70% of theoretical discharge capacity at a tenth cycle. In one embodiment of the electrochemical device, a discharge capacity of the electrochemical device is greater than 80% of theoretical discharge capacity at a tenth cycle.

The invention also provides a method for stabilizing an electron pair donor liquid electrolyte solvent and a solid state doped or undoped LLZO electrolyte having a first surface and an opposed second surface in a lithium-sulfur battery having a sulfur-containing cathode facing the first surface of the LLZO electrolyte and a lithium metal anode contacting the second surface of the LLZO electrolyte. The method can comprise treating the first surface of the LLZO electrolyte with an acid before contacting the first surface of the LLZO electrolyte with a liquid electrolyte including a lithium metal salt and the electron pair donor liquid electrolyte solvent. The acid can be selected from the group consisting of H₃PO₄, HCl, HNO₃, H₂SO₄, and mixtures thereof. The acid can be H₃PO₄. The acid can be HCl.

In the method, the electron pair donor liquid electrolyte solvent can have a donor number (DN) greater than 15 kcal/mol, or a donor number (DN) greater than 20 kcal/mol, or a donor number (DN) greater than 25 kcal/mol. The electron pair donor liquid electrolyte solvent can comprise N,N-dimethylacetamide (DMA). The method may further comprise including in the liquid electrolyte at least one glyme solvent. The electron pair donor liquid electrolyte solvent can comprise a solvent mixture including 1,3-dioxolane (DOL) and 1,2-dimethoxyethane (DME). The method may further comprise impregnating the liquid electrolyte in a porous separator layer. The method may further comprise arranging a gasket adjacent a perimeter of the separator layer to contain the liquid electrolyte in the separator layer. In the method, an interfacial resistance of an interface of the LLZO electrolyte and the liquid electrolyte can be 100 Ωcm² or less. In the method, an interfacial resistance of an interface of the LLZO electrolyte and the liquid electrolyte can be 50 Ωcm² or less, or 30 Ωcm² or less. The treated first surface of the solid state doped or undoped electrolyte can include phosphate groups. The treated first surface of the solid state doped or undoped electrolyte can include Li₃PO₄. The treated first surface of the solid state doped or undoped electrolyte can include a phosphorylated layer. The phosphorylated layer can have a thickness in a range of 1-30 nanometers, or in a range of 1-20 nanometers, or in a range of 5-15 nanometers.

### EXAMPLES

The following Examples are provided in order to demonstrate and further illustrate certain embodiments and aspects of the present invention and are not to be construed as limiting the scope of the invention. The statements provided in the Examples are presented without being bound by theory.

### Example 1

### Introduction

Lithium-sulfur (Li—S) batteries are a promising next generation battery technology. With sulfur's high discharge capacity of 1,672 mAh/g coupled with a lithium metal anode, the battery has a significant theoretical energy density. Beyond the fact that Li—S offers significantly higher energy density than lithium-ion batteries, their benefits extend to better safety and lower cost. However, in a conventional Li—S battery with a liquid electrolyte, the battery suffers from unstable Li metal cycling and is plagued from the “polysulfide shuttle effect.” During the discharge process of sulfur, lithium polysulfide compounds form, solubilize in the electrolyte, and shuttle between electrodes leading to parasitic reactions, irrecoverable capacity loss, low Coulombic efficiency, and impedance growth. In an all-solid-state configuration with a solid electrolyte (SE), this polysulfide shuttle does not occur although forming good solid-solid contact at the cathode/solid electrolyte interface remains a challenge with resulting high impedances and sluggish kinetics. The addition of a liquid electrolyte (LE) at the solid electrolyte/cathode interface can simultaneously improve contact and ionic transport while the solid electrolyte acts as a physical barrier to protect the Li metal and isolate polysulfides to the cathode. Several authors have demonstrated this dual electrolyte configuration to successfully block the polysulfides and improve Li—S performance.

Recently, studies have probed the interactions between various solid and liquid electrolytes. Busche et al. first demonstrated that a solid-liquid electrolyte interphase (SLEI) spontaneously forms on the Nasicon-type materials and LiPON due to the decomposition of the solvent and salt. These SLEIs interfacial impedance vary significantly over time and strongly depend on the solvent and salt. The interfacial impedance can be several hundred to several thousand Ωcm² and lead to high activation energy for ion transport. In general, 1,3-dioxolane (DOL), an electron pair donor (EPD) solvent which has a donor number (DN) of 21.3 kcal/mol, forms a much lower interfacial impedance with LiPON and Nasicon-type materials than 1,2-dimethoxyethane (DME), a glyme solvent which has a donor number (DN) of 20 kcal/mol. The DOL/LiPON SLEI stabilizes to an interfacial impedance of ˜100 Ωcm² after several hours while DME/LiPON SLEI increases to 1,500 Ωcm² after 6 days without plateauing. This large interfacial impedance will lead to a significant overpotential and energy loss in commercially relevant cells [Ref. 1.11, 1.14, 1.19]. Following studies elucidated similar findings that an SLEI forms on garnet LLZO with a variety of liquid electrolytes. Fu et al. and Naguib et al. went further showing that LLZO and sulfur are thermodynamically incompatible and react to yield a sulfate/sulfide SLEI in glyme electrolytes.

These studies into the SLEI have only investigated some glymes, carbonates, and acetonitrile. Electron pair donor (EPD) solvents represent a different class of solvents with large implications in the Li—S field. The pioneering work by Cuisinier et al. showed EPDs highly solvate polysulfide species and can deliver 24% more capacity than conventional glyme electrolytes with near full utilization of sulfur (1,575 mAh/g versus 1,300 mAh/g) [Ref. 1.21]. This capacity increase is due to the S₃·⁻ radical stabilized in EPDs that acts as a redox mediator for further sulfur discharge. Unfortunately, EPD solvents are not stable with lithium. Li—S cells based on EPD solvents have low Coulombic efficiency and quickly short [Ref. 1.21].

Thus, a dual electrolyte configuration will not only physically block polysulfides to protect Li but will separate EPD solvents to protect them from the Li. Overall, the SE/LE interface remains a complicated component of dual electrolyte-based batteries. For dual electrolytes to be on par with Li-ion electrolyte/electrode interfaces, the SE/LE interface must be lower than 55 Ωcm². Therefore, there is a need to minimize the SE/LE interfacial impedance and investigate the compatibility between EPD solvents and solid electrolytes and minimize the EPD/SE interfacial impedance. In this Example 1, we use LLZO due to its stability with Li metal and compare its stability in EPD and glyme electrolytes. 1 M LiTFSI in N,N-dimethylacetamide (DMA), an electron pair donor (EPD) solvent which has a donor number (DN) of 27.8 kcal/mol, was the representative EPD solvent due to the work by Cuisinier et al., and 1 M LiTFSI in DOL:DME (1:1 v/v) the representative glyme due to its prevalence in the literature. We used a heat treatment, HCl acid treatment, and H₃PO₄ acid treatment of LLZO to minimize the LLZO/LE interface and explore its effects on the LLZO surface chemistry. We show that LLZO and EPD electrolytes are incompatible in the presence of sulfur. A simple H₃PO₄ acid treatment creates a buffer layer on the LLZO surface to stabilize the electrolytes yielding a LLZO/DMA interfacial impedance of 87 Ωcm². No deleterious effects are observed in glyme electrolytes.

### Experimental Details

### LLZO Preparation/Symmetric Cell

Li_{6.5}La₃Ta_{0.5}Zr_{1.5}O₁₂ powder was synthesized through a solid-state route and then densified into billets using rapid-induction hot pressing (RIHP). The LLZO billet was then cut into pellets and polished to a 0.1 μm finish. To clean the surface of LLZO, the polished pellets were heat treated (HT) at 400° C. for 3 hours in an argon-filled glovebox [Ref. 1.18]. For HCl treatment, the LLZO pellets were submerged in 1 M HCl for 30 seconds, then rinsed with acetone, dried with a heat gun, and then quickly transferred to a glovebox. For the H₃PO₄ treatment, the LLZO pellets were submerged in 85% H₃PO₄ for 5 minutes under sonication to ensure better reaction owing to the high viscosity of the acid. The pellets were then rinsed with acetone, dried with a heat gun and then quickly transferred to a glovebox. These will be referred to as HT-LLZO, HCl-LLZO, and HPO-LLZO.

A S/LE/LLZO/LE/S symmetric cell was designed to investigate the LLZO/LE interface. Sulfur was chosen as the electrode for two reasons: first, a sulfur electrode is more realistic for catholyte studies than Li, and second, Li is not stable in contact with EPDs. FIG. 1A is a schematic of the symmetric cell. Pellets were placed against an perfluoro elastomer O-ring in a ½′ Swagelok union. A glass-fiber separator (GFS) flooded with the electrolyte of choice was placed on each side of the LLZO for sufficient solid-liquid contact. A sulfur cathode composite from the NEI Corporation (0.5 cm², 3.36 g/cm³) was then placed on each exposed glass-fiber separator face and compressed to form a hermetic seal. DOL:DME and DMA solvents were dried with molecular sieves for 3 days to minimize water contamination. Each solvent was mixed with bis(trifluoromethanesulfonyl)imide (LiTFSI) for 24 hours to form a 1 M solution. The LiTFSI was dried under vacuum at 120° C. for 24 hours prior to mixing. Potentiostatic electrochemical impedance spectroscopy (PEIS) was performed every 6 hours for 3 days to monitor the LLZO/LE interface. PEIS was performed from 7 MHz to 1 Hz with a 10 mV perturbation. The first impedance measurement was taken within 5 minutes of cell assembly.

### XPS Experimental

XPS analysis was performed on a Thermo ESCALAB 250 instrument using a non-monochromatic Al Kα source. The samples were transported to the spectrometer under an Ar atmosphere and transferred into the chamber anaerobically. All spectra were fitted with the Gaussian-Lorentzian functions and a Shirley-type background. The binding energy values were all calibrated using the C 1s peak at 284.8 eV. S 2p and P 2p peaks were fitted by sulfur doublets with the area ratio of 2:1 and the peak splitting of 1.18 eV and 0.86 eV respectively. Zr 3d peaks were fitted with the 3d_{5/2}-3d_{3/2} doublet with the area ratio of 3:2 and the splitting of 2.43 eV. The La 3d XPS was fitted with the two sets of 3d_{5/2}-3d_{3/2} doublets (main peaks and satellites). The full width at half maximum (FWHM) was identical for both spin-orbit coupling components of the peaks. For sputtering experiments, a X-ray spot size of 400 μm was sputtered using a 3 kV Ar⁺ ion beam over an area of about 1.5 mm×1 mm at a rate of approximately 1 nm·min⁻¹.

### Full Cell Set Up

After heat treatment of the LLZO, 750 μm thick lithium foil ( 5/16″, Alfa Aesar) was attached to one side of the LLZO in an argon-filled glovebox. Prior to attachment the lithium foil was scraped to remove surface contaminants until visually shiny and uniform. The Li/LLZO was then compressed and heated to 170° C. for at least 4 hours to form homogenous contact and low Li/LLZO interfacial resistance. Li/LLZO/Li symmetric cells confirmed the low interfacial resistance and a critical current density of at least 1 mA/cm². The Li/LLZO was assembled into a similar Swagelok union and compressed under 3.4 MPa to seal the lithium side from the LE/S which can be seen in FIG. 1B, panel a). For a DMA-based dual electrolyte, the exposed LLZO surface was H₃PO₄ acid treated. For DOL:DME-based dual electrolyte, the exposed LLZO surface was HCl acid treated.

Upon transfer to a glovebox, 20 μL of 1 M LiTFSI in DOL:DME or DMA was dropped on top of the LLZO and a sulfur cathode (NEI Corporation, 3.36 mg S/cm²) was added. A layer of carbon paper was included between the LLZO/S to assist with electrical connection of the cathode. The Li—S dual electrolyte cell was cycled galvanostatically between 1.7-2.9 V vs Li/Li⁺ at a 0.1 mA/cm² current density at room temperature. EIS was performed between each cycle to assess impedance evolution.

### Results and Discussion

### LLZO/LE Interface Impedance

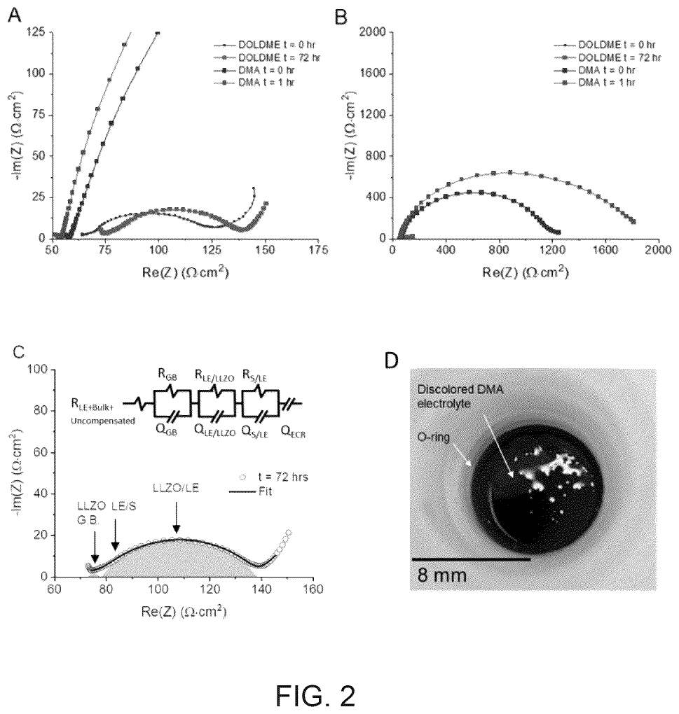

FIG. 2, panels a) and b), show representative Nyquist plots of the symmetric cell of HT-LLZO/DOL:DME and HT-LLZO/DMA. The equivalent circuit model used to analyze the Nyquist plots is in FIG. 2, panel c). The equivalent circuit contains an ohmic resistor, 4 RQ circuits, and a constant phase element. These represent the liquid electrolyte bulk, LLZO bulk, LLZO grain boundary, LLZO/LE interface, LE/S interface, and electrode double layer capacitance, respectively. The LLZO bulk and grain boundary and LE/S interface contributions were measured separately and used to deconvolute the LLZO/LE interface. Our model accurately fits the characteristic capacitances predicted by Irvine et al.: bulk, grain boundary, and interfaces have characteristic capacitances of 10⁻¹² F, 10⁻⁸ F, and 10⁻⁶ F, respectively [Ref. 1.22]. The fit of the model is seen in FIG. 2, panel c).

After extracting R_{LLZO/LE} from our model, it can be seen that right after initial SE/LE contact, the DOL:DME/HT-LLZO forms a moderately low interphase with an average areal resistance of 68 Ωcm². After 3 days, the areal resistance negligibly increased to an average value of 72 Ωcm². This behavior indicates a thermodynamically stable interphase between DOL:DME/HT-LLZO and differs from the behavior between HT-LLZO/acetonitrile and ethylene carbonate/dimethyl carbonate [Ref. 1.18,1.19]. The HT-LLZO/DOL:DME has a characteristic frequency of ca. 1.3 kHz, in good agreement with the literature for SLEIs. In contrast, DMA/HT-LLZO has radically different results. Immediately after SE/LE contact the areal resistance is >1,250 Ωcm², already drastically higher than the DOL:DME/HT-LLZO interphase after 3 days. The DMA/HT-LLZO shows rapid growth and within 1 hour after contact the areal resistance increased to >1,750 Ωcm². Extended testing of this symmetric cell indicates uncontrollable growth with the areal resistance approaching 20,000 Ωcm² after 3 days. Postmortem analysis of the DMA/HT-LLZO symmetric cell revealed the DMA electrolyte turned into a deep red-purple color, FIG. 2, panel d), whereas neat DMA is a clear liquid with a slight yellowish hue.

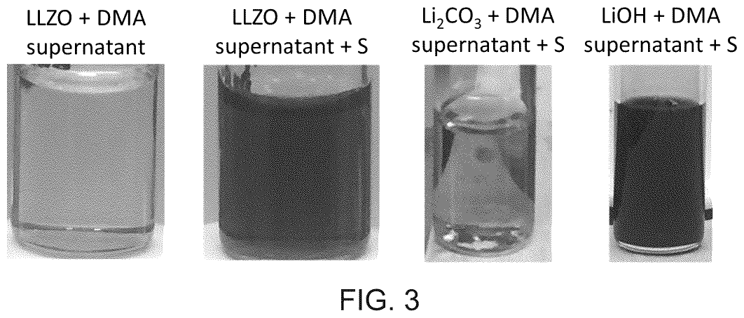

It is known that the surface of LLZO is contaminated with Li₂CO₃ and LiOH [Ref. 1.23]. Heat treatment of LLZO reduces the contamination to satisfactory levels (>90%) for Li/LLZO interface compatibility, although the heat treatment does not completely clean the surface. To elucidate the influence of these surface groups, Li₂CO₃ and LiOH were separately added to DMA solutions with excess sulfur. The Li₂CO₃ solution turned a faint blue hue while the LiOH solution turned into the same deep red/purple color of the HT-LLZO/DMA solution (FIG. 3). It is known that EPD solvents are capable of stabilizing various colorful sulfur species. Hojo et al. showed that elemental sulfur can be reduced from nucleophilic attack by hydroxide species to a S₃·⁻ radical [Ref. 1.24]. This radical has a bluish color in EPD solvents. In the presence of excess sulfur, the S₃·⁻ radical dimerizes into S₆²⁻ giving the red solution [Ref. 1.25]. This indicates that remaining surface hydroxides on HT-LLZO spontaneously react with dissolved sulfur to form various sulfur species. As more sulfur is consumed during nucleophilic attack and subsequent dimerization, the integrity of the cathode fails. These parasitic reactions are likely the cause for the uncontrollable resistance growth in the EPD electrolyte. Glyme electrolytes are unable to stabilize the S3′ radical, allowing for DOL:DME to have a low resistance and compatible interface with LLZO even with remaining surface hydroxides [Ref. 1.21]. Li₂CO₃ likely gave a color change due to surface hydroxide terminal groups. These experiments were repeated with 1 M LiTFSI in DMA solutions with no discernible difference showing no influence from the salt. It should be noted that previous studies on SE/LE interfaces typically use Li as an electrode, which would not have had the issue of S reduction in DMA. These results highlight the importance of using a realistic cathode as the electrode for SE/LE studies.

Recently, Huo et al. used a simple acid treatment to clean the surface of LLZO [Ref. 1.26]. The acid treatment was confirmed to have completely removed the resistive LLZO surface of contaminants and improved the Li/LLZO interface. To neutralize surface hydroxides and stabilize LLZO/DMA, we employed two different acid treatments of LLZO. After heat treatment, LLZO pellets were submerged in either 1 M HCl for 30 seconds and washed with acetone or submerged in H₃PO₄ and washed ethanol.

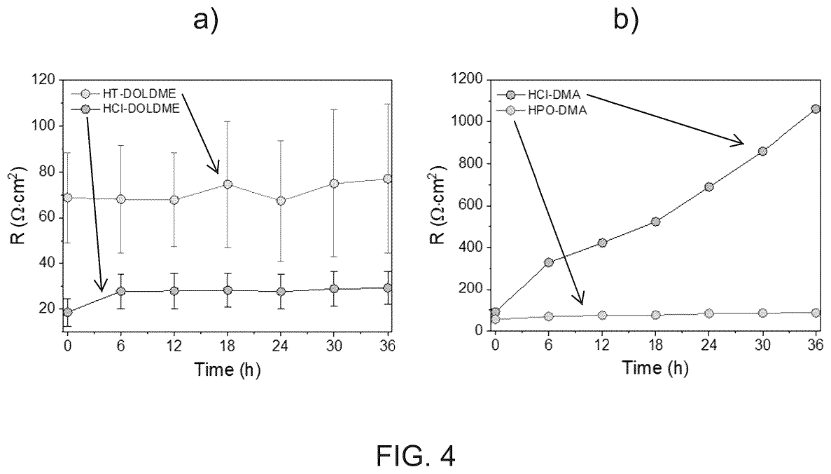

After acid washing, the LLZO pellets were immediately transferred into a symmetric Swagelok cell to test their compatibility with DMA in the presence of sulfur through EIS. Right after cell assembly it can be seen in FIG. 4, panel b) that both acid treatments initially stabilize the DMA/LLZO interface. From the data fitting HCl-LLZO/DMA and HPO-LLZO/DMA form an initial interface of 91 Ωcm² and 57 Ωcm², respectively. Removing the surface hydroxides on LLZO to prevent sulfur reduction dramatically improves the initial DMA/LLZO stability and lowers the initial impedance by 93-95%. However, the temporal evolution of the HCl-LLZO/DMA impedance behaves similarly to the HT-LLZO/DMA and continues to increase without reaching a limit. Within 36 hours the impedance surpasses 1,000 Ωcm². Postmortem analysis of the DMA electrolyte reveals the same red/purple discoloration. In unique contrast, the HPO-LLZO/DMA moderately increases to only 87 Ωcm² after 36 hours and remains consistent for the rest of the experiment. Disassembly of the symmetric cell shows no discoloration of the DMA electrolyte. Thus, the HPO acid treatment successfully stabilizes the DMA/LLZO and sulfur interactions. Further optimization of the LLZO/DMA interface remains, though this represents a crucial advancement in implementing an EPD electrolyte for Li—S battery cells. The difference in compatibility between HCl-LLZO and HPO-LLZO in DMA/S shows that simple removal of the surface hydroxides is a necessary but not sufficient condition.

As the HCl acid wash of LLZO cleans the LLZO surface more efficiently than a heat treatment, we investigated the HCl acid treatment on the LLZO/DOL:DME interface. The Nyquist plots of the HT-LLZO and HCl-LLZO against DOL:DME are shown in FIG. 4, panel a). Remarkably, immediately after cell assembly the HCl acid treatment enables an exceptionally low DOL:DME/RAT-LLZO areal resistance of 13 Ωcm². The temporal evolution of the interfacial impedance is shown in FIG. 4, panel b). Within 6 hours the DOL:DME/HCl-LLZO interface quickly plateaus to 27 Ωcm² and remains flat over the rest of the experiment. This represents a significant 62.5% decrease compared to the HT-LLZO/DOL:DME SLEI. We attribute this exceptionally low impedance to the pristine LLZO surface. HCl removes all the resistive surface compounds and does not generate a thin, protective, yet mildly resistive chloride layer. To the best of our knowledge, it is the lowest reported areal resistance for a LLZO/LE interface and is well below the SE/LE interface requirement of 55 Ωcm².

### Li—S Battery Dual Electrolyte Cycling

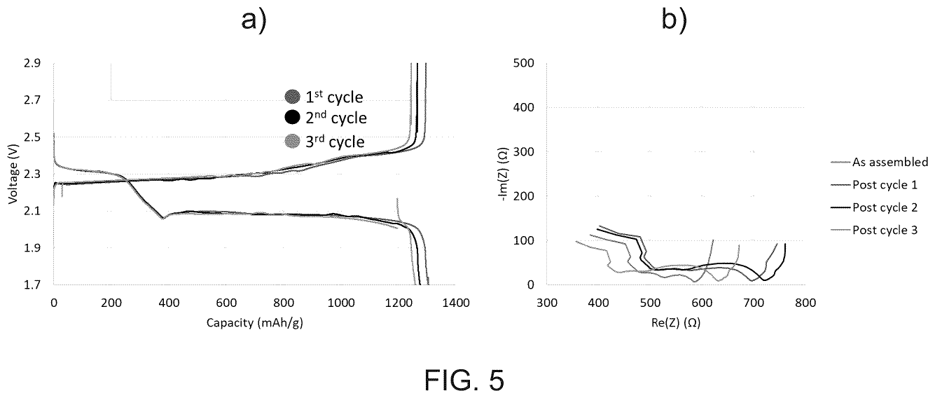

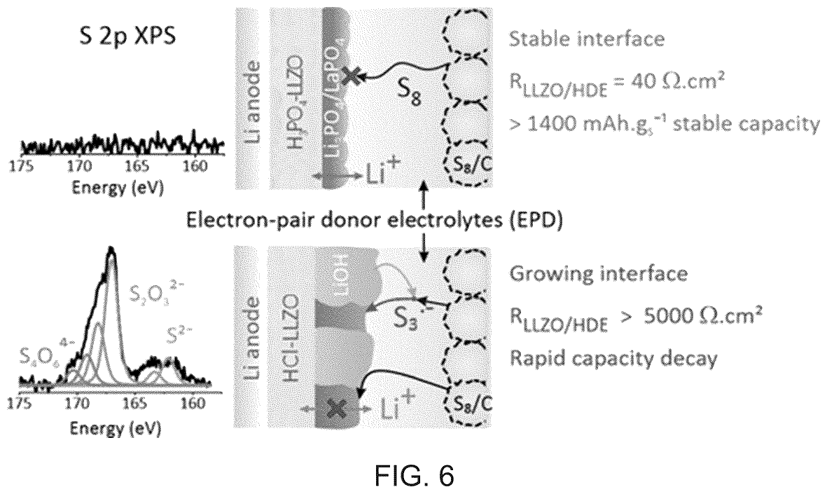

To gauge the performance of the acid-treated dual electrolyte, a full Li—S cell was studied. FIG. 5, panels a),b) show the performance of a Li/HCl-LLZO/DOL:DME/S cell cycled at 0.1 mA/cm² and corresponding Nyquist plots. The dual electrolyte cell discharges with the two plateaus characteristic of a liquid Li—S cell. It delivers a high first discharge capacity of 1,302 mAh/g (based on mass of sulfur) and maintains a Coulombic efficiency >99% for multiple cycles. The voltage profiles are identical to liquid Li—S cells with no overcharge indicative of the polysulfide shuttle. Thus, LLZO does not impede the cycling behavior of Li—S cells and it functions as a barrier to stop the shuttle effect. As the first discharge plateau (˜2.2 V) is repeatable from cycle to cycle, the capacity loss can be attributed to forming nonconductive lithium sulfides and losing electrical contact [Ref. 1.12]. Orange/yellow precipitates were seen throughout the Swagelok union during postmortem analysis. These precipitates are likely the insoluble discharge products Li₂S/Li₂S₂, pointing towards the discussed capacity loss mechanism. Furthermore, there is very minimal increase in polarization over the course of cycling. This is in agreement with the impedance evolution over cycling. Due to the Li/LLZO and LLZO/DOL:DME sharing similar frequency ranges, deconvoluting their individual contribution is contemplated. Nevertheless, as both interfaces play an important role, the total interfacial resistance (Li/LLZO+LLZO/LE) in the cell is evaluated. Two hours after cell assembly, the total interfacial resistance is an exceptionally low 32 Ωcm², in agreement with earlier symmetric cell data. The total interfacial resistance spikes to 70 Ωcm² after the first cycle, but then stabilizes to 78 Ωcm² for the following two cycles. Previous studies showed that there is inherent instability between LLZO and lithium polysulfides and an SLEI interphase composed of carbonaceous species and sulfate/sulfide species forms [Ref. 1.15, 1.17]. Further characterization of the SLEI composition is required, but our thorough impedance study shows that unsurprisingly the SLEI impedance changes depending on static versus dynamic conditions.

### Conclusions

In this Example 1, we showed for the first time that LLZO and electron pair donor catholytes are inherently unstable for a Li—S battery. Instability arises from both residual hydroxides on the garnet surface and reactivity of the La³⁺ within the bulk garnet where each can attack dissolved sulfur. We developed a rapid H₃PO₄ acid wash of LLZO that forms a spontaneous Li₃PO₄ surface film to act as a buffer layer. This HPO-LLZO remains stable in electron pair donor/sulfur contact to form an interphase with a low resistance of 87 Ωcm². A similar HCl acid wash readily cleans the LLZO surface to enable an ultralow 27 Ωcm² interfacial resistance with DOL:DME.

### Example 2

### Overview

Conventional Li—S batteries rely on liquid electrolytes based on LiNO₃/DOL/DME mixtures that produce a quasistable interface with the lithium anode. Electron pair donor (EPD) solvents, also known as high donor number solvents, provide much higher polysulfide solubility and close-to-ideal sulfur utilization, making them solvents of choice for lean electrolyte Li—S cells. However, their instability to reduction requires incorporation of an ion-conductive membrane that is stable with Li, such as garnet LLZO and also stable with sulfur/polysulfides. In this Example 2, we report that even trace amounts of LiOH on a LLTZO surface trigger a complex reaction with sulfur dissolved in typical EPD solvents (i.e., N,N-dimethylacetamide, DMA) to produce a highly resistive impedance layer that quickly grows with time from 1000 to 10,000 Ωcm² over a few hours, thus impeding Li⁺ transport across the interface. Decorating the LLZO with protective phosphate groups to produce a modified surface provides a very low charge-transfer resistance of 40 Ωcm² that is maintained over time and inhibits the reaction of LiOH and dissolved sulfur. Hybrid liquid-solid electrolyte cells constructed on this concept result in a high sulfur utilization of 1400 mAh g⁻¹ which is 85% of theoretical and remains constant over cycling even with conventional, unoptimized carbon/sulfur cathodes.

### Introduction

Li-ion batteries are today's electrochemical energy storage technology of choice for portable devices, electric vehicles, and even storage grid applications [Ref. 2.1, 2.2], but they are approaching their energy density limitations based on the intercalation chemistry that lies at their foundation. This, together with factors of cost and inorganic mineral/metal resources, is prompting accelerated research in alternative battery systems that go beyond the state-of-the-art Li-ion. Li—S batteries are prominent among these. They benefit from a high theoretical specific energy density of 2560 Wh kg⁻¹ and a potential full cell energy density of 600 Wh kg⁻¹ owing to the multielectron redox reactions of the sulfur cathode [Ref. 2.3].

It is now widely understood that for a Li—S cell to achieve even 500 Wh kg⁻¹, a low electrolyte to sulfur (E/S) ratio of approximately 1 μL·mg⁻¹ is required [Ref. 2.4]. Operating Li—S cells at such low E/S ratios poses a massive challenge because conventional DOL-DME electrolytes have limited polysulfide (PS) solubility. The resulting PS saturation in the electrolyte leads to increased viscosity and altered electrolyte transport properties that ultimately dictate sluggish kinetics for both the charge and discharge processes [Ref. 2.5]. Furthermore, the aggravated precipitation of Li₂S under such conditions creates thick Li-ion-blocking layers on the cathode surface, shutting down the redox processes in the cell.

Highly solvating electrolytes based on electron pair donor (EPD) solvents, also termed high donor number solvents, were proposed long ago because they dissolve higher concentrations of PS and can provide better transport properties [Ref. 2.6]. They also sustain unique polysulfide speciation equilibria on redox as a result of stabilization of the trisulfide radical (S₃·⁻). These solvents include dimethyl sulfoxide (DMSO), N,N-dimethylacetamide (DMA), 2-methylimidazole (MeIM), 2,6-dimethyl imidazolidinone (DMI), and tetramethyl urea (TMU), which can potentially dissolve Li₂S₈ at high concentrations (DMSO (14.3 M), DMA (32 M), MeIM (16M), DMI (36 M), and TMU (10.5M) [Ref. 2.7-2.9]) compared to DOL-DME, which reaches a limit at about 7 M [Ref. 2.10] based on sulfur. Previously, some of us reported on a Li—S cell using 1 M LiTFSI in DMA as the electrolyte with LATP serving as a second solid electrolyte to prevent reduction of the DMA at the Li surface. We initially observed that with a typical sulfur cathode, almost 25% more capacity was observed with DMA than TEGDME [Ref. 2.11]. The primary factor responsible for the higher capacity lies in the intrinsic property of DMA (and other EPD solvents) in stabilizing the trisulfide radical (S₃-). The formation and consumption of this species during redox were directly monitored via operando XANES studies, owing to its characteristic pre-edge spectral feature. These studies showed that the trisulfide radical reacts with other PS species through disproportionation reactions to maintain PS species in complex solution equilibria, thus delaying precipitation of Li₂S on discharge or S₈ on charge. Its function as an internal redox mediator leads to increased active material utilization. While EPD solvents promise higher sulfur utilization and better electrochemical performance, two major challenges still exist and need to be overcome: (1) increased PS solubility results in aggravated polysulfide shuttle leading to sulfur loss, anode corrosion, and low Coulombic efficiency; and (2) all EPD solvents are highly reactive with Li metal and cannot form a favorable SEI on the lithium metal anode.

Ta-substituted garnet, Li_{6.5}La₃Ta_{0.5}Zr_{1.5}O₁₂ (LLTZO), is a promising solid electrolyte as a physical barrier to inhibit EPD reduction and mitigate polysulfide crossover. Research has overwhelmingly shown that LLZO is stable with lithium metal [Ref. 2.12, 2.13], can be “interface-engineered” to enhance charge transfer [Ref. 2.14], and capable of forming an ultralow interfacial resistance interface (<2 Ωcm²) [Ref. 2.15]. Implementing a solid physical barrier in a liquid lithium-sulfur cell leads to a symbiotic dual electrolyte configuration [Ref. 2.16-2.21]. The physical barrier inhibits solvent reduction and any crosstalk arising from PS diffusion in the cell, and the liquid electrolyte (LE) simultaneously can ease typical sluggish solid-solid kinetics and reduce high solid-solid interfacial resistance. Such a dual electrolyte configuration aims to achieve the benefits of both solid and liquid electrolytes. However, other studies have shown that in this case, the formation of a resistive solid-liquid electrolyte interphase (SLEI) is thermodynamically favored [Ref. 2.22, 2.23]. Gupta et al. demonstrated that the choice of lithium-conducting salt greatly influences the SLEI resistance [Ref. 2.24]. They showed that in a symmetric cell with graphite electrodes in the same solvent LiTFSI easily forms a stable interface with LLZO, whereas LiBOB and LiPF₆ do not. Other work has investigated SLEI formation between LLZO and 1 M LiTFSI in DOL-DME. Fu et al. showed a sulfur-rich SLEI comprised of Li₂S and Li₂SO₄ which was formed on LLZO after it was soaked in Li₂S₈ solution [Ref. 2.25]. Naguib et al. similarly demonstrated the formation of a thick (75-90 nm) Li and S-rich SLEI that exhibited a continuously increasing interfacial resistance of several thousand Ωcm² during rest at OCV and upon cycling [Ref. 2.26]. This high resistance interphase was attributed to decomposition of the LiTFSI salt. These large SLEI resistances are not sustainable for Li—S batteries. For hybrid Li—S cells to compete with cells with liquid electrolytes, the SLEI resistance needs to be minimized to compensate for the voltage drop observed during high-current density cell operation and ensure sufficient Li⁺ transport across the interface [Ref. 2.27].

While there has been early research on the interactions between LLZO and common glyme or carbonate electrolytes [Ref. 2.24-2.27], there is yet to be any studies on EPD solvents. Here, we explore the compatibility between LLZO and EPD solvent DMA and compare it to a conventional DOL-DME electrolyte. However, LLTZO is thought to be chemically stable in organic electrolytes; we find that LLTZO is incompatible with sulfur cathodes in DMA due to trace amounts of LiOH on the LLTZO surface, even when the garnet is heated to 400° C. to remove the residue. In DMA, surprisingly, the surface hydroxide reduces sulfur from the cathode that is dissolved in solution, thereby saturating the electrolyte with polysulfide species and leading to a remarkable and rapid impedance increase and hence poor electrochemical behavior. Furthermore, La in LLTZO reacts with dissolved polysulfides to form a lanthanum oxysulfide layer at the surface of the garnet, which also increases the cell impedance and negatively affects electrochemical performance. Herein, we report that a rapid H₃PO₄ acid treatment phosphorylates the garnet surface, significantly reducing the interfacial resistance and leading to greatly improved cell performance. It forms a Li₃PO₄ layer that results in a low interfacial interface of 40 Ωcm² and inhibits the reaction of surface impurities with sulfur in an EPD solvent such as DMA. The hybrid Li—S cells constructed with phosphorylated garnet and a LiTFSI/DMA electrolyte deliver a high capacity of 1410 mAh g⁻¹ and reversibly maintain a capacity retention of almost 100% over cycling, thus providing a promising avenue to implement EPD solvents as electrolytes in Li—S batteries.

### Experimental Section

### EIS Measurements and Fitting of the Impedance Data

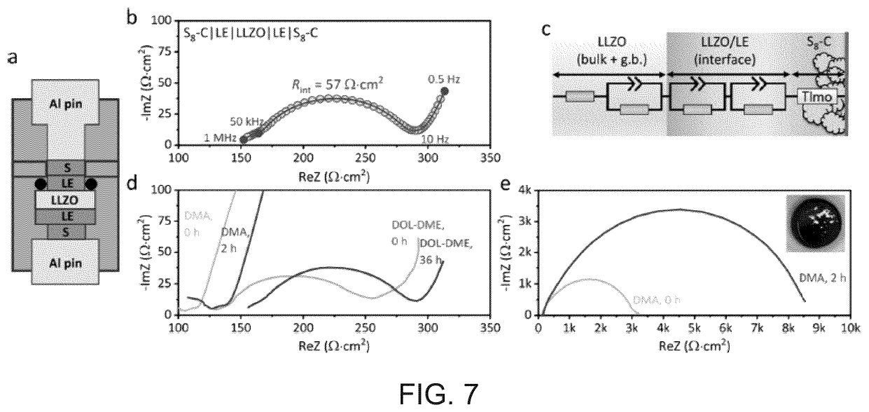

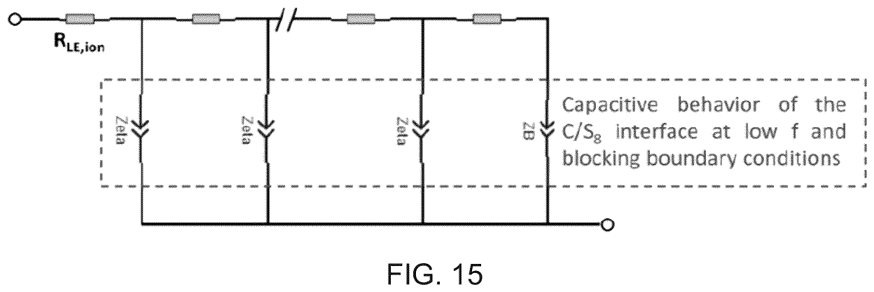

The EIS of the symmetric cells with S₈/C electrodes was measured at 25° C. in the frequency range between 1 MHz and 0.5 Hz with a 10 mV amplitude. The impedance data was fitted with the equivalent circuit shown in FIG. 7 panel c. The resistance of LLZO (bulk and grain boundary) was attributed to the frequency range between 1 MHz and 50 kHz. The resistance of the LLZO/LE interface is extracted from the range from 50 kHz to 10 Hz. The blocking and capacitive behavior of the S₈/C electrodes below 10 Hz was fitted with the transmission line model (TLM) shown in FIG. 15.

### LLZO Synthesis

Li_{6.5}La₃Ta_{0.5}Zr_{1.5}O₁₂ powder was synthesized through a solid-state route and then densified into billets by using rapid-induction hot pressing (RIHP). The LLZO billet was then cut into pellets and polished to a 0.1 μm finish. To clean the surface of LLZO, the polished pellets were heat treated at 400° C. for 3 hours in an argon-filled glovebox.

### RAT of LLZO Pellets

The LLZO pellets were immersed into 1 M HCl or 85% H₃PO₄ and allowed to react for 30 seconds or 5 minutes, respectively. They were then washed multiple times with acetone, dried with a heat gun, and then quickly transferred to an Ar-filled glovebox for further analysis. Due to the high viscosity of H₃PO₄, the vials with LLZO and H₃PO₄ were sonicated to achieve better mixing and avoid bubble formation.

### Sulfur Cathode Preparation

A sulfur composite with 70 wt. % sulfur and 30 wt. % Ketjen Black carbon was prepared through melt diffusion at 155° C. This composite was then mixed with Super P and PTFE (60 wt. % dispersion in water, Sigma-Aldrich) in the weight ratio of 77:10:13 in isopropanol. The obtained mixture was then rollcast directly onto a carbon coated Al foil. After drying overnight at 60° C., the foil were punched into 8 mm discs to obtain the sulfur cathodes with a nominal loading of 3 mg·cm⁻².

### Sulfur Symmetric Cell Setup

LLZO pellets were placed against an FFKM O-ring in a 12′ Swagelok union. A glass-fiber separator (GFS) flooded with the electrolyte of choice (1 M LiTFSI in DMA or 1 M LiTFSI in DOL-DME) was placed on each side of the LLZO for sufficient solid-liquid contact. A sulfur cathode was then placed on each exposed glass-fiber separator face and compressed to form a hermetic seal. PEIS was performed from 7 MHz to 1 Hz with a 10 mV perturbation. The first impedance measurement was taken within 5 minutes of cell assembly.

### Full Cell Setup

After heat treatment of the LLZO, 750 μm thick lithium foil ( 5/16 in. Alfa Aesar) was attached to one side of the LLZO in an argon-filled glovebox. Prior to attachment, the lithium foil was scraped to remove surface contaminants until it was shiny and uniform. Li/LLZO was then compressed and heated to 170° C. for at least 4 hours to form a homogeneous contact and low Li/LLZO interfacial resistance. Li/LLZO/Li symmetric cells confirmed the low interfacial resistance and a critical current density of at least 1 mA/cm². Li/LLZO was assembled into a similar Swagelok union and compressed under 3.4 MPa to seal the lithium side from the liquid electrolyte/S₈. The Li—S hybrid electrolyte cell was galvanostatically cycled between 1.8 and 2.9 V versus Li/Li⁺ at a 0.1 mA/cm² current density at room temperature. A layer of P50 carbon paper soaked with electrolyte (held constant at 12 uL/mg S) was used to enhance the electrical wiring.

### UV-Vis Measurements

UV-vis measurements were carried out on a Thermo Scientific Evolution 201 UV-visible spectrophotometer. Samples were loaded in quartz cuvettes with a path length of 1 mm inside a glovebox and then analyzed within a wavelength range of 400-800 nm.

### XPS Measurements

X-ray photoelectron spectroscopy (XPS) analysis was performed on a Thermo ESCALAB 250 instrument. Monochromatic and nonmonochromatic Al Kα sources were used for conductive composite and nonconductive materials, respectively. The samples were transported to the spectrometer under an Ar atmosphere and transferred to the chamber anaerobically. All spectra were fitted with Gaussian-Lorentzian functions and a Shirley-type background. The binding energy values were all calibrated using the C 1s peak at 284.8 eV. S 2p, and P 2p peaks were fitted by sulfur doublets with an area ratio of 2:1 and a peak splitting of 1.18 and 0.86 eV, respectively. Zr 3d peaks were fitted with the 3d_{5/2}-3 d_{3/2} doublet with an area ratio of 3:2 and a splitting of 2.43 eV. The La 3d spectrum was fitted with two sets of 3d_{5/2}-3 d_{3/2} doublets (main peaks and satellites). The full width at half-maximum (fwhm) was identical for both spin-orbit coupling components of the peaks. For sputtering experiments, an X-ray spot size of 400 μm was sputtered using a 3 kV Ar⁺ ion beam over an area of about 1.5 mm×1 mm at a rate of approximately 1 nm·min⁻¹.

### ¹H NMR Measurements

¹H NMR measurements were obtained on a Bruker Avance II spectrometer at 7.05 T. The ¹H spectra were recorded at 300 MHz in a 0.5 mm OD tube with no solvent lock.

### Results and Discussion

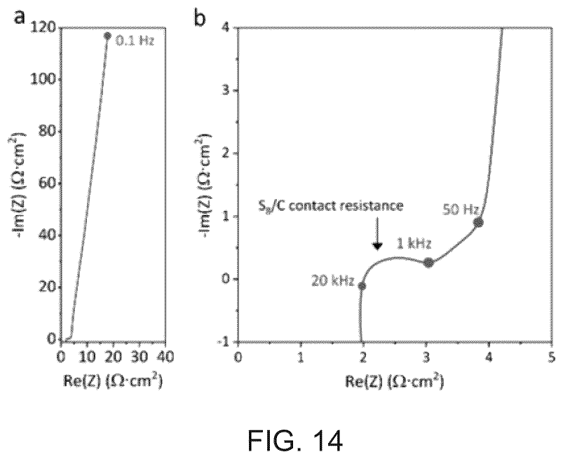

The interfacial compatibility between LLZO and liquid electrolytes (LEs) was explored using electrochemical impedance spectroscopy (EIS) of symmetric cells. We employed simple sulfur/carbon electrodes (S:Ketjen black; 70:30 by weight) in a Swagelok-type cell modified with an O-ring seal to prevent electrolyte leakage (FIG. 7 panel a). The S₈-C|LE|LLZO|LE|S₈-C design was adopted from Barchasz and coworkers [Ref. 2.28] to eliminate impedance contributions from the Li anode. The S₈-C electrodes exhibit a very low resistance of 4 Ωcm² (FIG. 14) generated by electrical interparticle contacts [Ref. 2.29], where the cell impedance is primarily dictated by the LLZO and SLEI.

LLZO was heat treated at 400° C. to clean the surface prior to the EIS measurements [Ref. 2.10] (denoted HT-LLZO). A representative Nyquist plot of the symmetric cell with HT-LLZO and 1 M LiTFSI/DOL-DME (FIG. 7 panel b) comprises three frequency-separated regions. The equivalent circuit model used to analyze the Nyquist plots was adopted from studies of other SE/LE electrolyte interfaces (FIG. 7 panel c) [Ref. 2.22, 2.24, 2.27]. The high-frequency portion of the spectrum (>50 kHz) includes the bulk (R_{bulk}) and grain boundary (R_{gb}) resistance from LLZO.

The contribution of R_{gb} to the total impedance of LLZO is ˜5%. The LLZO/LE interface is represented by two depressed semicircles (R₁ and R₂) that lie between 50 kHz and 10 Hz. The impedance of a single LLZO/LE interface (Rᵢₙₜ) was calculated as the algebraic average between R₁ and R₂. The capacitive contribution of the S₈-C blocking electrodes (the tail below 10 Hz) was fitted by a transmission line model (TLM) with a blocking boundary condition (see FIG. 15).

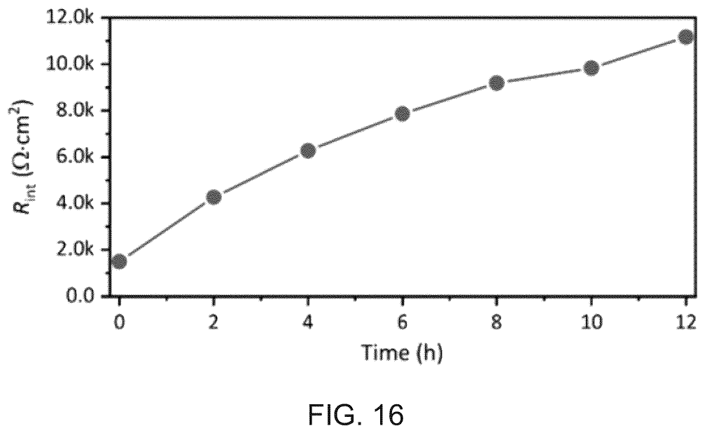

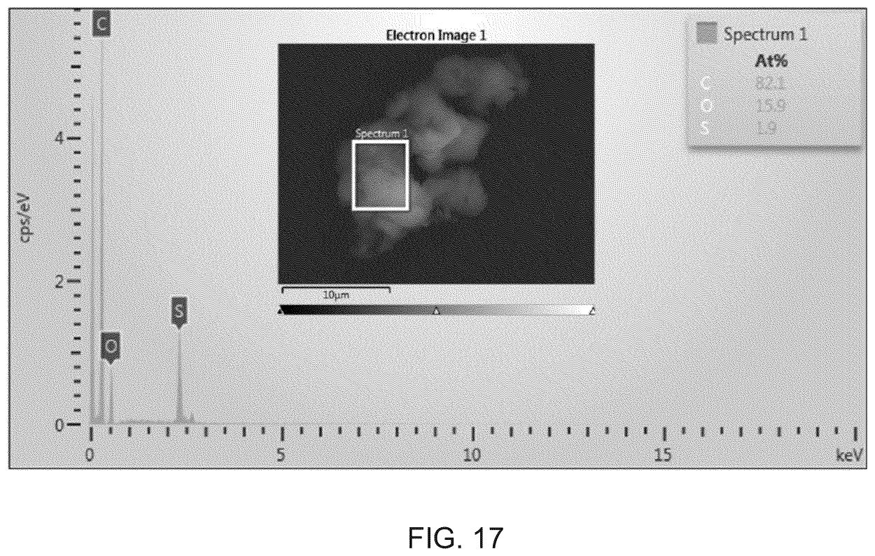

The notable difference in the interfacial stability of the symmetric S₈/C cells in DOL-DME vs. that in DMA is illustrated in FIG. 7 panels d,e. The cells in DOL-DME exhibit a low initial Rᵢₙₜ of ˜50 Ωcm² that increased only slightly to 56 Ωcm² after 36 hours of storage. This behavior indicates that a stable interphase is formed, unlike that exhibited by HT-LLZO/acetonitrile or ethylene carbonate/dimethyl carbonate, which show increasing resistance under the same storage conditions [Ref. 2.24, 2.26, 2.27]. The stable interfacial impedance of HTLLZO/DOL-DME is also in sharp contrast with the behavior of the SLEI formed between HT-LLZO and DMA, where the initial Rᵢₙₜ of ˜1500 Ωcm² grew to 11,000 Ωcm² after 12 hours of aging (see FIG. 16). The ˜7-fold increase in Rᵢₙₜ suggests pronounced surface reactivity between LLZO and the dissolved sulfur, which was evident by the post-mortem analysis of the symmetric cells that revealed that the DMA electrolyte had turned deep burgundy (FIG. 7 panel d). EDX analysis (FIG. 17) of the solute obtained after solvent evaporation of the liquid showed signatures corresponding to only C, O, and S, indicating that the liquid was composed of polysulfides. To understand the nature of the reaction and the interphase formed on the garnet, we combined spectroscopic measurements (UV-vis; XPS; and ¹H NMR) performed on the electrolyte harvested from the symmetric cell and on the garnet. These are described below.

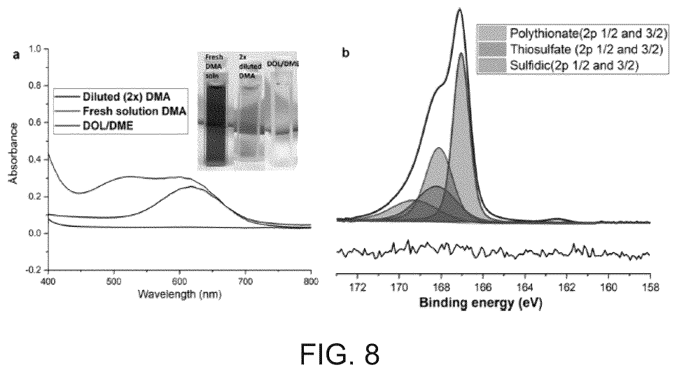

Surface Chemistry. UV-vis spectroscopy was performed on the burgundy electrolyte obtained from the S₈-C/HT-LLZO/DMA cell to identify the possible sulfidic species that are present. As shown in FIG. 8 panel a, a very broad overlapped spectral feature spanning the region between 450 and 700 nm was observed, where two peaks can be roughly deconvoluted: one at ˜510 nm that is identified as the S₆²⁻ anion and one at 620 nm characteristic of the trisulfide radical [Ref. 2.29]. When this solution was diluted (2×) with more DMA, the resultant pale blue solution revealed only the peak due to the S₃⁻ radical. The change in the spectrum upon dilution clearly indicates a shift in the equilibrium toward S₃⁻ as explained below. On the other hand, the electrolyte obtained from the DOL-DME cell was colorless and the spectrum (black trace) was devoid of any PS peaks.

The garnet surface in contact with the electrolyte was also analyzed by X-ray photoelectron spectroscopy (XPS; FIG. 8 panel b). The S 2p spectrum (wine trace) of the garnet pellet used in the DMA cell exhibited peaks corresponding to oxidized sulfur species, in particular polythionate (2p_{1/2}-2p_{3/2} spin doublet at 169.3-168.1 eV) and thiosulfates (2p_{1/2}-2p_{3/2} spin doublet at 168.2-167 eV) and a very minor fraction of reduced sulfur species (2p_{1/2}-2p_{3/2} at 163.6-162.4 eV), while the S 2p spectrum (black trace) from the garnet pellet used in the DOL-DME cell showed no discernible features.

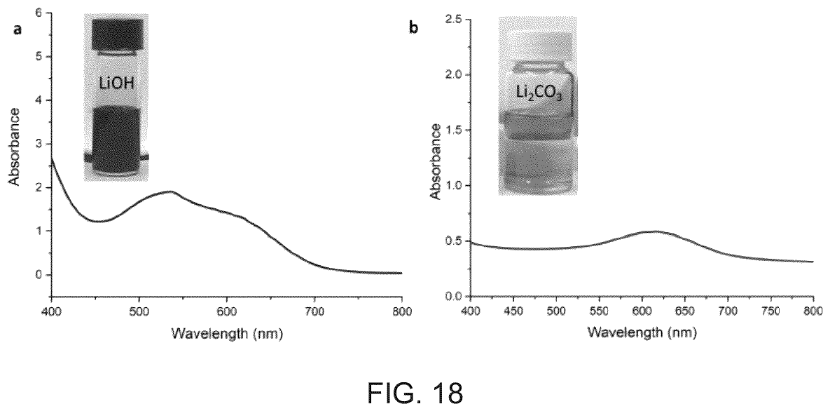

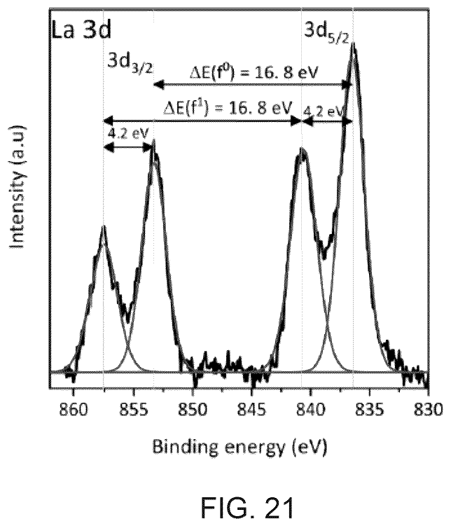

LiOH and Li₂CO₃ are known contaminants on the LLZO surface that exist in trace quantities even after heat treatment [Ref. 2.15]. To probe the reactivity of these surface impurities, small amounts of LiOH and Li₂CO₃ were separately added to colorless solutions of elemental sulfur dissolved in DMA. In the case of LiOH, the resultant deep burgundy solution yielded a UV-vis spectrum identical to FIG. 8 panel a, indicative of S₆²⁻/S₃⁻, whereas Li₂CO₃ containing solution turned faint blue; accordingly, its spectrum showed only the presence of the trisulfide radical (see FIG. 18). These results suggest that reduction of sulfur to polysulfide anions (i.e., S₆²⁻) is triggered by LiOH, which is fairly soluble in DMA (limit of 15 mM at room temperature). This phenomenon has been previously reported [Ref. 2.30] in a similar EPD solvent (DMSO), wherein the stabilization of the trisulfide radical proved to be a contributing factor in the sulfur reduction reaction. DOL-DME, in contrast, has almost no solubility for LiOH. The supernatant liquid collected by washing LLZO with DMA immediately turned blue when sulfur was added to it (FIG. 21), further indicating LiOH solubility.

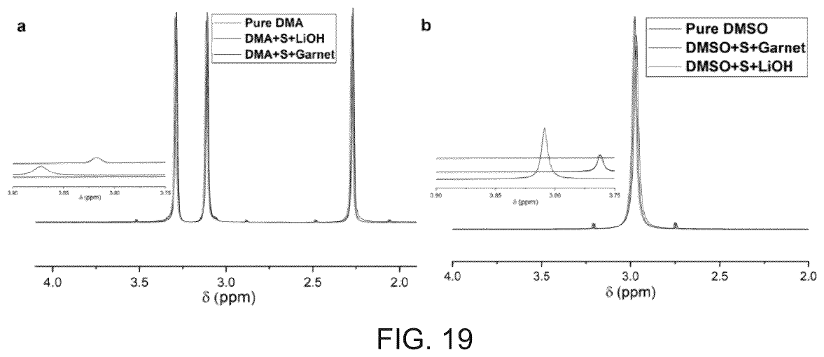

Reactive intermediate species such as the superoxide radical in the Li—O₂ battery or the trisulfide radical in Li—S batteries are known to initiate solvent degradation [Ref. 2.11, 2.31]. The deep burgundy liquid obtained from the symmetric cell and a control solution obtained from the reaction of LiOH, sulfur, and DMA were thus subjected to ¹H NMR analysis to examine possible reactivity. FIG. 19 shows that new peaks appear at δ=3.82 ppm for the liquid from the symmetric cell and at δ=3.87 ppm for the liquid obtained from the LiOH, sulfur and DMA reaction along with the major solvent peaks. While these new signals might be a result of solvent decomposition, the chemical shift is more in accordance with higher order hydrogen polysulfides (H₂Sₙ) [Ref. 2.32]. Solutions obtained by mixing LLZO, sulfur, and DMSO (another EPD solvent); and LiOH, sulfur, and DMSO also showed two new peaks at δ=3.76 and 3.81 ppm in the ¹H NMR spectrum, indicating the presence of higher order polysulfides.

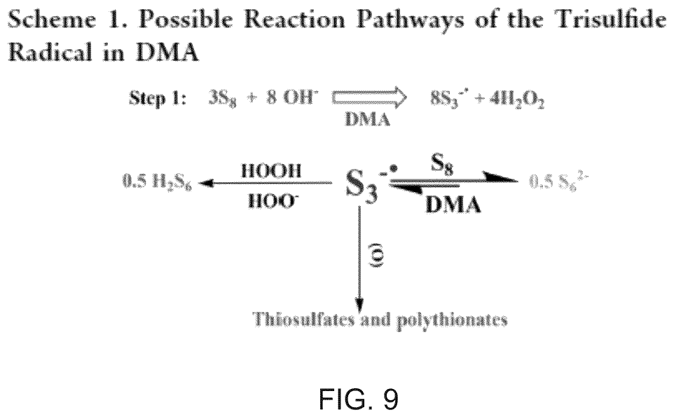

Based on the observed results, we propose Scheme 1 (see FIG. 9) to account for the observed reactivity in DMA. Step 1 is the known reaction [Ref. 2.30] of LiOH with sulfur in EPD solvents such as DMA and DMSO to form the trisulfide radical and hydrogen peroxide. The trisulfide radical that forms can abstract hydrogen from hydrogen peroxide to form hydrogen polysulfides, be oxidized to form thiosulfates and polythionates, or dimerize to form the deep red hexasulfide dianion at a high concentration. The latter condition would predominate in the symmetric cell owing to the continuous release and reaction of sulfur in the cathode in solution with dissolved hydroxide. The massive impedance growth in the cell is attributed to the buildup of insoluble thiosulfates/polythionates on the garnet surface [Ref. 2.25].

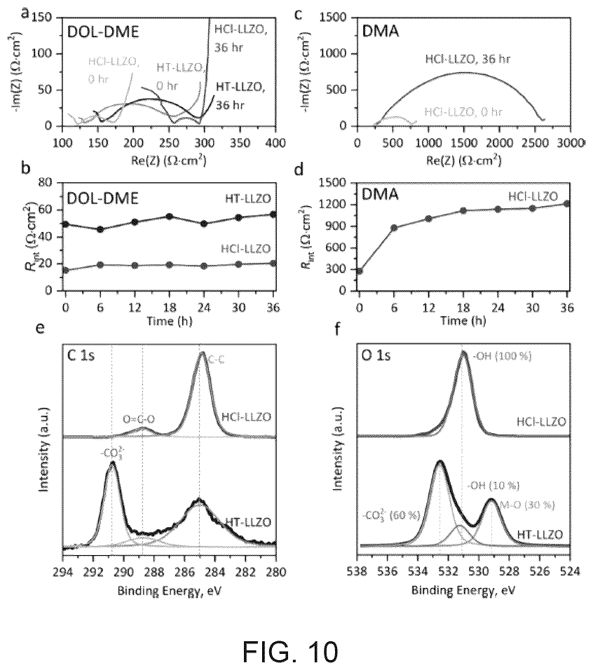

Since the reaction pathway involves the residual surface LiOH present on HT-LLZO, we employed a rapid acid treatment (RAT) of LLZO with 1 M HCl (denoted as HCl-LLZO). This method was proposed by Huo et al. to remove Li₂CO₃ from the LLZO surface [Ref. 2.33]. HCl-RAT results in a 2.5-fold reduction in impedance from 50 Ωcm² (HT-LLZO) to 15 Ωcm² (HCl-LLZO) in Rᵢₙₜ of the sulfur symmetric cells with DOL-DME (FIG. 10 panel a). Due to the diminished reactivity between HT-LLZO and sulfur in DOL-DME, the lower Rᵢₙₜ of HCl-LLZO is attributed to the increase in the contact area after the removal of surface impurities. The evolution of Rᵢₙₜ after 36 hours is similar for the cells with HT-LLZO and HCl-LLZO in DOL-DME (FIG. 10 panel b), implying that the reactivity of sulfur in DOL-DME is not affected by trace LiOH/Li₂CO₃ on the LLZO surface owing to its very low solubility. In the case of DMA (FIG. 10 panel c), although HCl-RAT reduced the Rᵢₙₜ of the assembled cell from 1500 to 300 Ωcm², the continuous growth in Rᵢₙₜ was not suppressed, and the cell exhibited a ˜4-fold increase of Rᵢₙₜ after 36 hours of storage (FIG. 10 panel d). Moreover, the initial Rᵢₙₜ of HCl-LLZO in DMA is still significantly higher than that in DOL-DME (20 Ωcm²), highlighting the inefficiency of HCl-RAT in completely removing hydroxide from the LLZO surface under mild treatment. This was confirmed by XPS studies. The C 1s and O 1s spectra of HT-LLZO and HCl-LLZO are shown in FIG. 10 panels e,f. After sputtering 10 nm of the HT-LLZO surface, Li₂CO₃ is still evident, in agreement with its reported thickness of 100 nm [Ref. 2.31]. The removal of Li₂CO₃ with HCl is confirmed by the absence of the peak at 291 eV in the C 1s spectrum (FIG. 10 panel e) of HCl-LLZO, consistent with the original report [Ref. 2.33].

The O 1s spectrum of HCl-LLZO and HT-LLZO reveals three major peaks, which are assigned to Li₂CO₃ (532.6 eV), LiOH (531.3 eV), and the LLZO lattice oxygen (529.2 eV) (FIG. 10 panel f) [Ref. 2.15, 2.34]. In the case of HT-LLZO, the surface is covered with Li₂CO₃ and LiOH, which contribute to 15 and 85% of the signal, respectively. After 10 minutes of sputtering, the fraction of LiOH drops to 10% and lattice oxygen appears at the level of 30%, indicating exposure of the LLZO native surface. Traces of Li₂CO₃ and LiOH are still present after 30 minutes of sputtering and contribute to 40 and 10% of the total signal, respectively (see Table S1).

TABLE S1
Distribution of oxygen species in the surface layer of the HT-
LLZO and HCl-LLZO before and after sputtering with Ar⁺ plasma.

| | HT-LLZO | | | HCl-LLZO | | |
|---|---|---|---|---|---|---|
| | 0 min | 10 min | 30 min | 0 min | 10 min | 20 min |
| Lattice O (%) | 0 | 30 | 50 | 0 | 20 | 40 |
| LiOH (%) | 85 | 10 | 10 | 100 | 80 | 60 |
| Li₂CO₃ (%) | 15 | 60 | 40 | 0 | 0 | 0 |

In the case of HCl-RAT, LiOH is the only component of the HCl-LLZO surface since Li₂CO₃ is completely removed by HCl. The concentration of LiOH exceeds 60% after 20 minutes of sputtering, which signifies the growth of a LiOH passivation layer during HCl-RAT. We attribute this to the competing Li⁺/H⁺ ion exchange reaction: HCl initially removes LiOH from the surface, but it is regenerated as Li⁺ from the lattice exchanges with H⁺. Thus, HCl-RAT ensures the removal of Li₂CO₃ but, at the same time, generates more LiOH at the surface, which results in the instability of the symmetric cells with S₈-C electrodes and DMA.

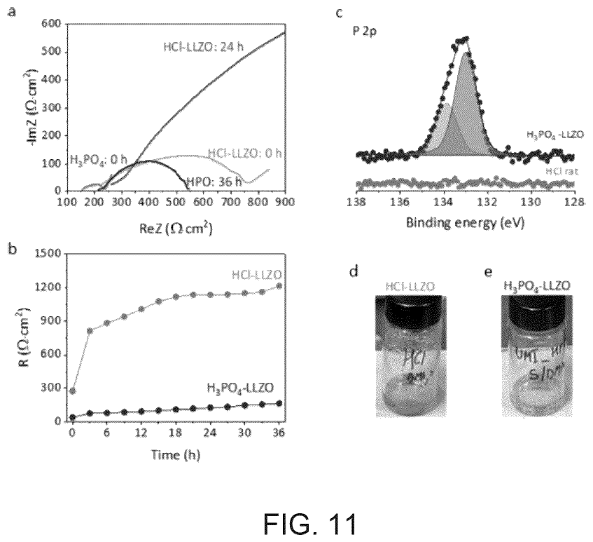

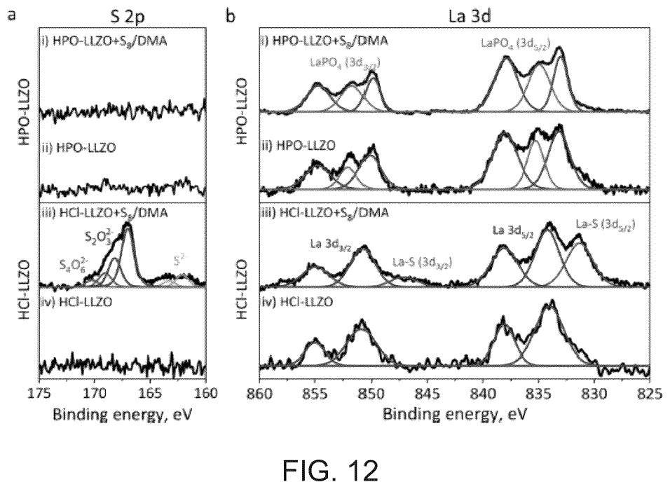

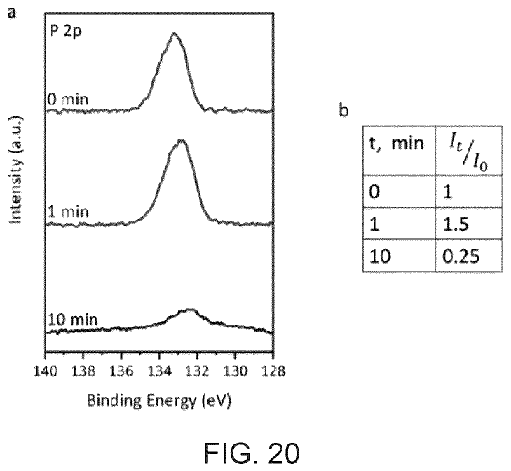

Reacting the native layer of LLZO with H₃PO₄ is a better method to modify the surface (denoted as HPO-LLZO) by effectively phosphorylating it. This approach has been demonstrated to improve the lithiophilicity of LLZO via converting the surface contaminants to Li₃PO₄ [Ref. 2.35, 2.36]. The significant improvement in the stability of HPO-LLZO with DMA is demonstrated by a ˜7-fold decrease in the Rᵢₙₜ of sulfur symmetric cells from 300 to 40 Ωcm² (FIG. 11 panels a,b). However, Rᵢₙₜ of HPO-LLZO increases on storage and it remains below that of HCl-LLZO (300 Ωcm²). The much lower interfacial impedance of LLZO after treatment with H₃PO₄ demonstrates that phosphorylation, as confirmed by P 2p XPS (FIG. 11 panel c), provides a more stable SLEI. Li₂CO₃ is not completely removed as confirmed by C is XPS (see FIG. 21). The phosphorylated layer is only about 10 nm thick because the P 2p signal is almost absent after Ar⁺ sputtering (see FIG. 20). The ionic conductivity of Li₃PO₄ in its amorphous state (10⁻⁶-10⁻⁸ mS·cm⁻¹) [Ref. 2.37, 2.38] is sufficient to facilitate ion transport across this thin layer. Thus, RAT with H₃PO₄ yields a protective layer, which not only reduces the dissolution of LiOH into DMA but also facilitates the transport of Li⁺ through the SLEI. The better compatibility of HPO-LLZO is also demonstrated by storing the pellets in a sulfur/DMA suspension. Although a suspension with HCl-LLZO produces the characteristic blue color within 1 hour, the HPO-LLZO suspension does not induce any color change (FIG. 11 panels d,e). This observation was confirmed by S 2p XPS (FIG. 12 panel a): namely, the S 2p spectrum of HPO-LLZO exposed to the S/DMA suspension for 2 days reveals no sulfur species on the surface, while that of HCl-LLZO shows peaks corresponding to Li₂S, Li₂S₂O₃, and Li₂S₂O₆.

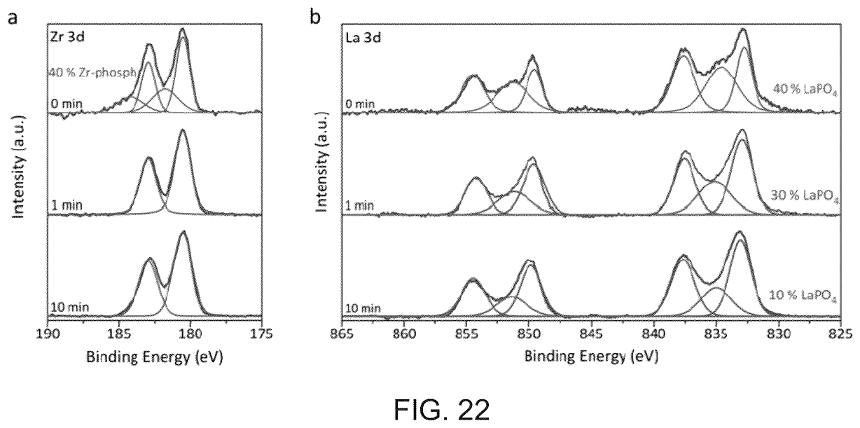

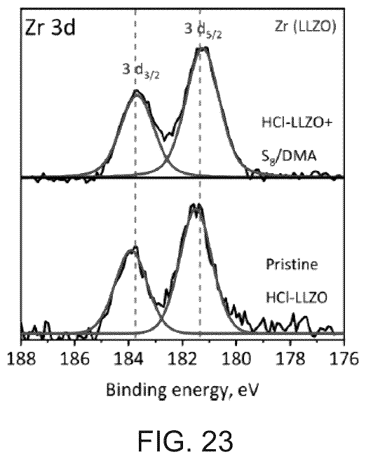

The protective role of the H₃PO₄ RAT of LLZO is furthermore evidenced by La 3d XPS studies. HCl-LLZO (FIG. 12 panel b,iv) and Ar-sputtered HT-LLZO (FIG. 21) exhibit two sets of La 3d doublets separated by 16.8 eV, in accordance with previous studies [Ref. 2.37]. H₃PO₄-RAT of HT-LLZO however converts some of the surface La and Zr to the corresponding phosphates [Ref. 2.39] (FIG. 12 panel b) as evidenced by the appearance of a third doublet at 181.7 and 184.3 eV (FIG. 22 panel a) [Ref. 2.40] and 851.8 and 835.0 eV (FIG. 22 panel b), respectively. The surface concentrations of LaPO₄ and Zr₃(PO₄)₄ are ˜40 atom % and vanish to <10% after 10 minutes of sputtering. Thus, the surface treatment by H₃PO₄ has a penetration depth of 10 nm, which passivates the surface La³⁺. In its absence, La³⁺ reacts with the dissolved sulfidic species, as demonstrated by the appearance of new peaks at lower binding energy (847 (3 d_{3/2}) and 831 (3 d_{5/2}) eV) in FIG. 12 panel b,iii. The reactivity of La³⁺ contrasts with the apparent stability of Zr⁴⁺ (see FIG. 23). This is consistent with the formation of La—S (or La—O—S) species on the surface of LLZO, which will increase the interfacial resistance. The reaction of La³⁺ with PS in DOL-DME resulting in the formation of La—S species or segregation of La₂O₃ has been reported by Wachsmann and co-workers [Ref. 2.41] and Wang and co-workers [Ref. 2.42]. The former group applied a LiFSI/PEO coating to the LLZO which improved the cyclability in DOL-DME [Ref. 2.41]. However, we note that PEO is readily dissolved in EPD solvents such as DMA, and therefore, it could not function as a protective interface in that medium. The H₃PO₄-derived coating completely eliminates side reactions while providing a low resistance interface.

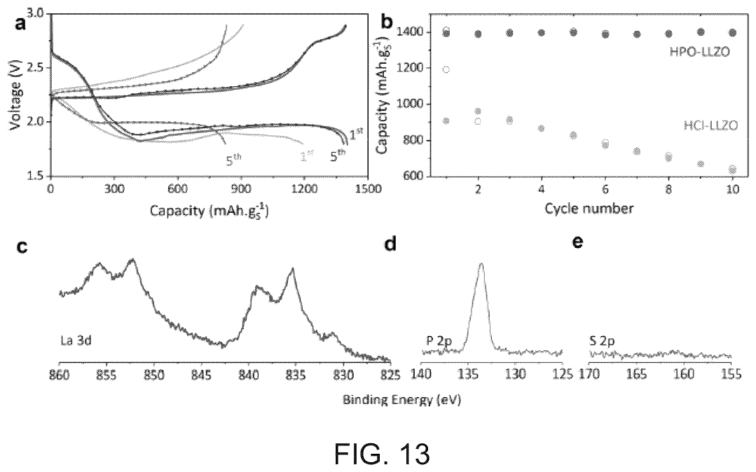

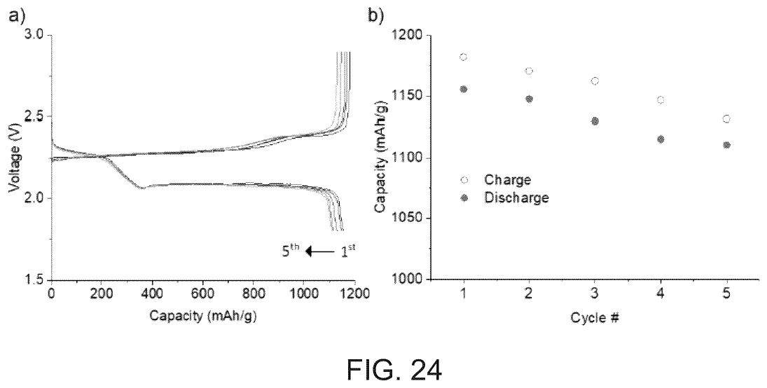

Li—S Cells with Protected LLZO. To gauge the performance of the HCl and HPO acid-treated garnets, we assembled Li∥S₈-C cells without any LiNO₃ in the liquid electrolyte. The performance of a cell with HCl-LLZO/DOL-DME cycled at 0.1 mA·cm⁻² is shown in FIG. 24. The hybrid electrolyte cell exhibits two plateaus characteristic of a DOL-DME liquid Li—S cell. The cell delivered a moderate first discharge capacity of 1175 mAh gₛ⁻¹ and maintained a Coulombic efficiency of >99% for several cycles. The voltage profiles are identical to liquid Li—S cells with no overcharge, indicative of the polysulfide shuttle. Thus, HCl-LLZO does not impede the cycling behavior of Li—S cells and successfully functions as a barrier to stop the shuttle effect. By the fifth cycle, the capacity faded to 1115 mAh gₛ⁻¹. This capacity loss is attributed to an unoptimized cathode architecture and a loss of sulfur from electrical isolation. A comparison between HCl and HPO-treated LLZO in Li∥S₈-C cells with DMA is shown in FIG. 13 panel a. The HCl-LLZO cell exhibits a first discharge capacity of 1193 mAh/g; by the fifth cycle, the discharge capacity fades to 825 mAh/g showing worse performance than the HCl-LLZO/DOL-DME cell. The low discharge capacity can be explained by a high overpotential from the high interfacial impedances described earlier. Similarly, this high impedance of the cell HCl-LLZO results in the increased polarization on charge and the disappearance of the voltage plateau at 2.7 V. Tuning the LLZO surface composition by the H₃PO₄ treatment permits implementation of DMA as an electrolyte (FIG. 13 panel a). The full Li∥S₈-C cell with HPO-LLZO/DMA achieves a very high capacity of 1410 mAh gₛ⁻¹ upon initial discharge. In contrast to the profile observed in the HCl-LLZO/DMA cell during discharge, two voltage plateaus are observed at 2.7 and 1.9 V for the HPO-LLZO/DMA cell [Ref. 2.11]. The cell exhibited remarkably stable cycling repeatedly discharging and charging 1,400 mAh/g (FIG. 13 panel b) with a conversion efficiency >99.3% until a power shutdown curtailed the cell at the 10th cycle. XPS of the cycled HPO-LLZO pellet (FIG. 13 panels c,d,e) clearly shows a pristine HPO-LLZO surface, with no observable sulfur signal reinforcing the resilience of the Li₃PO₄ layer. The excellent performance of the HPO-LLZO/DMA cell likely originates from the presence of the trisulfur radical, which acts as a redox mediator during charge to oxidize the other reduced polysulfide species [Ref. 2.11]. Thus, Li—S cells employing EPD solvents may exhibit high capacity retention without an engineered cathode architecture, although improvements to the latter are expected to extend the cycle life and enable lower E/S ratios. To the best of our knowledge, this is the first report that showcases highly reversible, high capacity Li—S redox in an EPD solvent.

### Conclusions

In Example 2, we report that native LLZO and electron pair donor (i.e., high donor number) solvent electrolytes are inherently incompatible with a Li—S battery. Reactivity arises from residual hydroxide on the garnet surface that dissolves and attacks sulfur in solution to form various sulfur species, including insoluble, insulating thiosulfates and polythionates that build up on the garnet surface. In turn, these sulfur species react with lanthanum in the LLZO to form La—S and/or La—O—S surface layers, dramatically increasing interfacial impedance and leading to high overpotential and poor capacity upon cycling. We developed a rapid H₃PO₄ acid wash treatment of LLZO that forms a Li₃PO₄ surface film to act as a buffer layer. This HPO-LLZO surface remains stable in electron pair donor solvent/sulfur contact to form an interphase with a low resistance of 40 Ωcm². An HCl acid wash is insufficient to modify the LLZO surface and exacerbates the parasitic reactions in DMA. Nevertheless, HCl sufficiently removes lithium carbonate from the LLZO surface to enable an ultralow 20 Ωcm² interfacial resistance with DOL-DME. This Example 2 shows that the symbiotic relationship between the LLZO and DMA in a hybrid configuration enables EPD electrolytes for Li—S batteries.

### REFERENCES

[1.1] U.S. Energy Information Administration (EIA), Monthly Energy Review (April 2022), Tables 1.3 and 2.1-2.6.
[1.2] Xiao, Yingjun, Jiaqi Fan, Xueyu Zhang, Dongyun Zhang, and Chengkang Chang. “Li₂Ni_{0.5}Mn_{1.5}O₄, Spinel Type Cathode Material with High Reversible Capacity.” Electrochemica Acta 311 (Jul. 10, 2019): 170-77.https://doi.org/10.1016/j.electacta.2019.04.162.
[1.3] Liu, Qi, Xin Su, Dan Lei, Yan Qin, Jianguo Wen, Fangmin Guo, Yimin A. Wu, et al. “Approaching the Capacity Limit of Lithium Cobalt Oxide in Lithium Ion Batteries via Lanthanum and Aluminium Doping.” Nature Energy 3, no. 11 (November 2018): 936-43.https://doi.org/10.1038/s41560-018-0180-6.
[1.4] Adelhelm, P. & Janek, J. in Handbuch Lithium-Ionen-Batterien (ed. Korthauer, R.) Ch. 16, 199-217 (Springer, 2013).
[1.5] Zou, Qingli, and Yi-Chun Lu. “Liquid Electrolyte Design for Metal-Sulfur Batteries: Mechanistic Understanding and Perspective.” EcoMat 3, no. 4 (2021): el2115.https://doi.org/10.1002/eom2.12115.
[1.6] Pan, Hui, Zhu Cheng, Ping He, and Haoshen Zhou. “A Review of Solid-State Lithium-Sulfur Battery: Ion Transport and Polysulfide Chemistry.” Energy & Fuels 34, no. 10 (Oct. 15, 2020): 11942-61.https://doi.org/10.1021/acs.energyfuels.0c02647.
[1.7] Hagen, M., S. Dörfler, H. Althues, J. Tübke, M. J. Hoffmann, S. Kaskel, and K. Pinkwart. “Lithium-Sulphur Batteries—Binder Free Carbon Nanotubes Electrode Examined with Various Electrolytes.” Journal of Power Sources 213 (Sep. 1, 2012): 239-48.https://doi.org/10.1016/j.jpowsour.2012.04.004.
[1.8] Vizintin, Alen, Manu U. M. Patel, Bostjan Genorio, and Robert Dominko. “Effective Separation of Lithium Anode and Sulfur Cathode in Lithium-Sulfur Batteries.” ChemElectroChem 1, no. 6 (2014): 1040-45.https://doi.org/10.1002/celc.201402039.
[1.9] Wang, Lina, Yonggang Wang, and Yongyao Xia. “A High Performance Lithium-Ion Sulfur Battery Based on a Li₂S Cathode Using a Dual-Phase Electrolyte.” Energy & Environmental Science 8, no. 5 (May 6, 2015): 1551-58.https://doi.org/10.1039/C5EE00058K.
[1.10] Wang, Qingsong, Jun Jin, Xiangwei Wu, Guoqiang Ma, Jianhua Yang, and Zhaoyin Wen. “A Shuttle Effect Free Lithium Sulfur Battery Based on a Hybrid Electrolyte.” Physical Chemistry Chemical Physics 16, no. 39 (Sep. 17, 2014): 21225-29.https://doi.org/10.1039/C4CP03694H.
[1.11] Yu, Xingwen, Zhonghe Bi, Feng Zhao, and Arumugam Manthiram. “Hybrid Lithium-Sulfur Batteries with a Solid Electrolyte Membrane and Lithium Polysulfide Catholyte.” ACS Applied Materials & Interfaces 7, no. 30 (Aug. 5, 2015): 16625-31.https://doi.org/10.1021/acsami.5b04209.
[1.12] Li, Wen, Jocelyn Hicks-Garner, John Wang, Jun Liu, Adam F. Gross, Elena Sherman, Jason Graetz, John J. Vajo, and Ping Liu. “V₂O₅ Polysulfide Anion Barrier for Long-Lived Li—S Batteries.” Chemistry of Materials 26, no. 11 (Jun. 10, 2014): 3403-10.https://doi.org/10.1021/cm500575q.
[1.13] Zhang, Zhiyong, Yanqing Lai, Zhian Zhang, Kai Zhang, and Jie Li. “Al₂O₃-Coated Porous Separator for Enhanced Electrochemical Performance of Lithium Sulfur Batteries.” Electrochimica Acta 129 (May 20, 2014): 55-61.https://doi.org/10.1016/j.electacta.2014.02.077.
[1.14] Busche, Martin R., Thomas Drossel, Thomas Leichtweiss, Dominik A. Weber, Mareike Falk, Meike Schneider, Maria-Louisa Reich, Heino Sommer, Philipp Adelhelm, and Jürgen Janek. “Dynamic Formation of a Solid-Liquid Electrolyte Interphase and Its Consequences for Hybrid-Battery Concepts.” Nature Chemistry 8, no. 5 (May 2016): 426-34.https://doi.org/10.1038/nchem.2470.
[1.15] Naguib, Michael, Asma Sharafi, Ethan C. Self, Harry M. III Meyer, Jeff Sakamoto, and Jagjit Nanda. “Interfacial Reactions and Performance of Li₇La₃Zr₂O₁₂-Stabilized Li—Sulfur Hybrid Cell.” ACS Applied Materials & Interfaces 11, no. 45 (Nov. 13, 2019): 42042-48.https://doi.org/10.1021/acsami.9b11439.
[1.16] Busche, Martin R., Manuel Weiss, Thomas Leichtweiss, Carsten Fiedler, Thomas Drossel, Matthias Geiss, Achim Kronenberger, Dominik A. Weber, and Jürgen Janek. “The Formation of the Solid/Liquid Electrolyte Interphase (SLEI) on NASICON-Type Glass Ceramics and LiPON.” Advanced Materials Interfaces 7, no. 19 (2020): 2000380.https://doi.org/10.1002/admi.202000380.
[1.17] Fu, Kun “Kelvin,” Yunhui Gong, Shaomao Xu, Yizhou Zhu, Yiju Li, Jiaqi Dai, Chengwei Wang, et al. “Stabilizing the Garnet Solid-Electrolyte/Polysulfide Interface in Li—S Batteries.” Chemistry of Materials 29, no. 19 (Oct. 10, 2017): 8037-41.https://doi.org/10.1021/acs.chemmater.7b02339.
[1.18] Gupta, Arushi, Eric Kazyak, Neil P. Dasgupta, and Jeff Sakamoto. “Electrochemical and Surface Chemistry Analysis of Lithium Lanthanum Zirconium Tantalum Oxide (LLZTO)/Liquid Electrolyte (LE) Interfaces.” Journal of Power Sources 474 (Oct. 31, 2020): 228598.https://doi.org/10.1016/j.jpowsour.2020.228598.
[1.19] Liu, Jingyuan, Xiangwen Gao, Gareth O. Hartley, Gregory J. Rees, Chen Gong, Felix H. Richter, Jürgen Janek, et al. “The Interface between Li_{6.5}La₃Zr_{1.5}Ta_{0.5}O₁₂ and Liquid Electrolyte.” Joule 4, no. 1 (Jan. 15, 2020): 101-8.https://doi.org/10.1016/j.joule.2019.10.001.
[1.20] Zhao, Meng, Bo-Quan Li, Xue-Qiang Zhang, Jia-Qi Huang, and Qiang Zhang. “A Perspective toward Practical Lithium-Sulfur Batteries.” ACS Central Science 6, no. 7 (Jul. 22, 2020): 1095-1104.https://doi.org/10.1021/acscentsci.0c00449.
[1.21] Cuisinier, Marine, Connor Hart, Mahalingam Balasubramanian, Arnd Garsuch, and Linda F. Nazar. “Radical or Not Radical: Revisiting Lithium-Sulfur Electrochemistry in Nonaqueous Electrolytes.” Advanced Energy Materials 5, no. 16 (2015): 1401801.https://doi.org/10.1002/aenm.201401801.
[1.22] Irvine, John T. S., Derek C. Sinclair, and Anthony R. West. “Electroceramics: Characterization by Impedance Spectroscopy.” Advanced Materials 2, no. 3 (March 1990): 132-38.https://doi.org/10.1002/adma.19900020304.
[1.23] Asma Sharafi, Eric Kazyak, Andrew L. Davis, Seungho Yu, Travis Thompson, Donald J. Siegel, Neil P. Dasgupta, and Jeff Sakamoto, Chemistry of Materials 2017 29 (18), 7961-7968, DOI: 10.1021/acs.chemmater.7b03002.
[1.24] Hojo, M., & Sawyer, D. T. (1989). “Hydroxide-induced reduction of elemental sulfur (S₈) to trisulfur anion radical (S₃·⁻)”. Inorganic Chemistry, 28(6), 1201-1202. https://doi.org/10.1021/ic00305a038
[1.25] Chivers, T., & Elder, P. J. (2013). “Ubiquitous trisulfur radical anion: Fundamentals and applications in materials science, electrochemistry”, Analytical Chemistry and Geochemistry. Chemical Society Reviews, 42(14), 5996-6005. https://doi.org/10.1039/c3cs60119f
[1.26] Huo, Hanyu, Yue Chen, Ning Zhao, Xiaoting Lin, Jing Luo, Xiaofei Yang, Yulong Liu, Xiangxin Guo, and Xueliang Sun. “In-Situ Formed Li₂CO₃-Free Garnet/Li Interface by Rapid Acid Treatment for Dendrite-Free Solid-State Batteries.” Nano Energy 61 (Jul. 1, 2019): 119-25.https://doi.org/10.1016/j.nanoen.2019.04.058.
[1.27] Su, Yu-Sheng, and Arumugam Manthiram. “Lithium-Sulphur Batteries with a Microporous Carbon Paper as a Bifunctional Interlayer.” Nature Communications 3, no. 1 (Nov. 6, 2012): 1166.https://doi.org/10.1038/ncomms2163.
[1.28] Zhao, Xiaohui, Gouri Cheruvally, Changhyeon Kim, Kwon-Koo Cho, Hyo-Jun Ahn, Ki-Won Kim, and Jou-Hyeon Ahn. “Lithium/Sulfur Secondary Batteries: A Review.” Journal of Electrochemical Science and Technology 7, no. 2 (Jun. 30, 2016): 97-114.https://doi.org/10.5229/JECST.2016.7.2.97.
[1.29] Wang, Michael J., Rishav Choudhury, and Jeff Sakamoto. “Characterizing the Li—Solid-Electrolyte Interface Dynamics as a Function of Stack Pressure and Current Density.” Joule 3, no. 9 (Sep. 18, 2019): 2165-78.https://doi.org/10.1016/j.joule.2019.06.017.
[1.30] Xie, Hua, Chunpeng Yang, Yaoyu Ren, Shaomao Xu, Tanner R. Hamann, Dennis Wayne McOwen, Eric D. Wachsman, and Liangbing Hu. “Amorphous-Carbon-Coated 3D Solid Electrolyte for an Electro-Chemomechanically Stable Lithium Metal Anode in Solid-State Batteries.” Nano Letters 21, no. 14 (Jul. 28, 2021): 6163-70.https://doi.org/10.1021/acs.nanolett.1c01748.
[1.31] Sagane, Fumihiro, Takeshi Abe, and Zempachi Ogumi. “Li⁺-Ion Transfer through the Interface between Li⁺-Ion Conductive Ceramic Electrolyte and Li⁺-Ion-Concentrated Propylene Carbonate Solution.” The Journal of Physical Chemistry C 113, no. 46 (Nov. 19, 2009): 20135-38.https://doi.org/10.1021/jp908623c.
[1.32] Yamada, Yuki, Fumihiro Sagane, Yasutoshi Iriyama, Takeshi Abe, and Zempachi Ogumi. “Kinetics of Lithium-Ion Transfer at the Interface between Li_{0.35}La_{0.55}TiO₃ and Binary Electrolytes.” The Journal of Physical Chemistry C 113, no. 32 (Aug. 13, 2009): 14528-32.https://doi.org/10.1021/jp9043539.
[1.33] Abe, Takeshi, Fumihiro Sagane, Masahiro Ohtsuka, Yasutoshi Iriyama, and Zempachi Ogumi. “Lithium-Ion Transfer at the Interface Between Lithium-Ion Conductive Ceramic Electrolyte and Liquid Electrolyte-A Key to Enhancing the Rate Capability of Lithium-Ion Batteries.” Journal of The Electrochemical Society 152, no. 11 (Sep. 21, 2005): A2151.https://doi.org/10.1149/1.2042907.
[1.34] Sharma, Manju, and S. Yashonath. “Correlation between Conductivity or Diffusivity and Activation Energy in Amorphous Solids.” The Journal of Chemical Physics 129, no. 14 (Oct. 14, 2008): 144103.https://doi.org/10.1063/1.2990744.
[2.1] Cano, Z. P.; Banham, D.; Ye, S.; Hintennach, A.; Lu, J.; Fowler, M.; Chen, Z., Batteries and Fuel Cells for Emerging Electric Vehicle Markets. Nat. Energy 2018, 3 (4), 279-289.
[2.2] Dunn, B.; Kamath, H.; Tarascon, J.-M., Electrical Energy Storage for the Grid: A Battery of Choices. Science 2011, 334 (6058), 928-935.
[2.3] Bruce, P. G.; Freunberger, S. A.; Hardwick, L. J.; Tarascon, J.-M., Li—O₂ and Li—S Batteries with High Energy Storage. Nat. Mater. 2012, 11 (1), 19-29.
[2.4] Bhargav, A.; He, J.; Gupta, A.; Manthiram, A., Lithium-Sulfur Batteries: Attaining the Critical Metrics. Joule 2020, 4 (2), 285-291.
[2.5] Shen, C.; Xie, J.; Zhang, M.; Andrei, P.; Hendrickson, M.; Plichta, E. J.; Zheng, J. P., Understanding the Role of Lithium polysulfide Solubility in Limiting Lithium-Sulfur Cell Capacity. Electrochim. Acta 2017, 248, 90-97.
[2.6] Liu, Y.; Elias, Y.; Meng, J.; Aurbach, D.; Zou, R.; Xia, D.; Pang, Q., Electrolyte Solutions Design for Lithium-Sulfur batteries. Joule 2021, 5, 2323-2364.
[2.7] Gupta, A.; Bhargav, A.; Manthiram, A., Highly Solvating Electrolytes for Lithium-Sulfur Batteries. Adv. Energy Mater. 2019, 9 (6), No. 1803096.
[2.8] Zhang, G.; Peng, H.-J.; Zhao, C.-Z.; Chen, X.; Zhao, L.-D.; Li, P.; Huang, J.-Q.; Zhang, Q., The Radical Pathway Based on a Lithium-Metal-Compatible High-Dielectric Electrolyte for Lithium-Sulfur Batteries. Angew. Chem., Int. Ed. 2018, 57 (51), 16732-16736.
[2.9] Baek, M.; Hyuksoo, S.; Kookheon, C.; Choi, J. W., New High Donor Electrolyte for lithium-sulfur batteries. Adv. Mater. 2020, 32, No. 2005022.
[2.10] Yanagi, M.; Ueno, K.; Ando, A.; Li, S.; Matsumae, Y.; Liu, J.; Dokko, K.; Watanabe, M., Effects of polysulfide Solubility and Li ion Transport on Performance of Li—S Batteries Using Sparingly Solvating Electrolytes. J. Electrochem. Soc. 2020, 167, No. 070531.
[2.11] Cuisinier, M.; Hart, C.; Balasubramanian, M.; Garsuch, A.; Nazar, L. F., Radical or Not Radical: Revisiting Lithium-Sulfur Electrochemistry in Nonaqueous Electrolytes. Adv. Energy Mater. 2015, 5 (16), No. 1401801.
[2.12] Wang, C.; Fu, K.; Kammampata, S. P.; McOwen, D. W.; Samson, A. J.; Zhang, L.; Hitz, G. T.; Nolan, A. M.; Wachsman, E. D.; Mo, Y.; Thangadurai, V., Garnet-Type Solid-State Electrolytes: Materials, Interfaces, and Batteries. Chem. Rev. 2020, 120 (10), 4257-4300.
[2.13] Samson, A. J.; Hofstetter, K.; Bag, S.; Thangadurai, V., A Bird's-Eye View of Li—Stuffed Garnet-Type Li₇La₃Zr₂O₁₂ Ceramic Electrolytes for Advanced All-Solid-State Li batteries. Energy Environ. Sci. 2019, 12 (10), 2957-2975.
[2.14] Van Den Broek, J.; Afyon, S.; Rupp, J. L., Interface-Engineered All-Solid-State Li-ion Batteries Based on Garnet-Type Fast Li⁺ Conductors. Adv. Energy Mater. 2016, 6 (19), No. 1600736.
[2.15] Sharafi, A.; Kazyak, E.; Davis, A. L.; Yu, S.; Thompson, T.; Siegel, D. J.; Dasgupta, N. P.; Sakamoto, J., Surface Chemistry Mechanism of Ultra-Low Interfacial Resistance in the Solid-State Electrolyte Li₇La₃Zr₂O₁₂. Chem. Mater. 2017, 29 (18), 7961-7968.
[2.16] Vizintin, A.; Patel, M. U.; Genorio, B.; Dominko, R., Effective Separation of Lithium Anode and Sulfur Cathode in Lithium-Sulfur Batteries. ChemElectroChem. 2014, 1 (6), 1040-1045.
[2.17] Wang, L.; Wang, Y.; Xia, Y., A High Performance Lithium-Ion Sulfur Battery Based on a Li₂S Cathode Using a Dual-Phase Electrolyte. Energy Environ. Sci. 2015, 8 (5), 1551-1558.
[2.18] Wang, Q.; Jin, J.; Wu, X.; Ma, G.; Yang, J.; Wen, Z., A Shuttle Effect Free Lithium Sulfur Battery Based on a Hybrid Electrolyte. Phys. Chem. Chem. Phys. 2014, 16 (39), 21225-21229.
[2.19] Yu, X.; Bi, Z.; Zhao, F.; Manthiram, A., Hybrid Lithium-Sulfur Batteries with a Solid Electrolyte Membrane and Lithium polysulfide Catholyte. ACS Appl. Mater. Interfaces 2015, 7 (30), 16625-16631.
[2.20] Li, W.; Hicks-Garner, J.; Wang, J.; Liu, J.; Gross, A. F.; Sherman, E.; Graetz, J.; Vajo, J. J.; Liu, P., V₂O₅ polysulfide Anion Barrier for Long-Lived Li—S Batteries. Chem. Mater. 2014, 26 (11), 3403-3410.
[2.21] Zhang, Z.; Lai, Y.; Zhang, Z.; Zhang, K.; Li, J., Al₂O₃-Coated Porous Separator for Enhanced Electrochemical Performance of Lithium Sulfur Batteries. Electrochim. Acta 2014, 129, 55-61.
[2.22] Busche, M. R.; Drossel, T.; Leichtweiss, T.; Weber, D. A.; Falk, M.; Schneider, M.; Reich, M.-L.; Sommer, H.; Adelhelm, P.; Janek, J., Dynamic Formation of a Solid-Liquid Electrolyte Interphase and Its Consequences for Hybrid-Battery Concepts. Nat. Chem. 2016, 8 (5), 426-434.
[2.23] Busche, M. R.; Weiss, M.; Leichtweiss, T.; Fiedler, C.; Drossel, T.; Geiss, M.; Kronenberger, A.; Weber, D. A.; Janek, J., The Formation of the Solid/Liquid Electrolyte Interphase (SLEI) on NASICON-Type Glass Ceramics and LiPON. Adv. Mater. Interfaces 2020, 7 (19), No. 2000380.
[2.24] Gupta, A.; Kazyak, E.; Dasgupta, N. P.; Sakamoto, J., Electrochemical and Surface Chemistry Analysis of Lithium Lanthanum Zirconium Tantalum Oxide (LLZTO)/Liquid Electrolyte(LE) Interfaces. J. Power Sources 2020, 474, No. 228598.
[2.25] Fu, K.; Gong, Y.; Xu, S.; Zhu, Y.; Li, Y.; Dai, J.; Wang, C.; Liu, B.; Pastel, G.; Xie, H.; Yao, Y.; Mo, Y.; Wachsman, E.; Hu, L., Stabilizing the Garnet Solid-Electrolyte/polysulfide Interface in Li—S Batteries. Chem. Mater. 2017, 29 (19), 8037-8041.
[2.26] Naguib, M.; Sharafi, A.; Self, E. C.; Meyer, H. M., III; Sakamoto, J.; Nanda, J., Interfacial Reactions and Performance of Li₇La₃Zr₂O₁₂-Stabilized Li—Sulfur Hybrid Cell. ACS Appl. Mater. Interfaces 2019, 11 (45), 42042-42048.
[2.27] Liu, J.; Gao, X.; Hartley, G. O.; Rees, G. J.; Gong, C.; Richter, F. H.; Janek, J.; Xia, Y.; Robertson, A. W.; Johnson, L. R.; Bruce, P. G., The Interface between Li_{6.5}La₃Zr_{1.5}Ta_{0.5}O₁₂ and Liquid Electrolyte. Joule 2020, 4 (1), 101-108.
[2.28] Walus, S.; Barchasz, C.; Bouchet, R.; Alloin, F., Electrochemical Impedance Spectroscopy Study of Lithium-Sulfur Batteries: Useful Technique to Reveal the Li/S Electrochemical Mechanism. Electrochim. Acta 2020, 359, No. 136944.
[2.29] Martin, R. P.; Doub, W. H., Jr; Roberts, J. L., Jr; Sawyer, D. T., Electrochemical reduction of sulfur in aprotic solvents. Inorg. Chem. 1973, 12 (8), 1921-1925.
[2.30] Hojo, M.; Sawyer, D. T., Hydroxide-Induced Reduction of Elemental Sulfur (S₈) to trisulfur Anion Radical (S₃⁻). Inorg. Chem. 1989, 28 (2), 1201-1202.
[2.31] Goolsby, A. D.; Sawyer, D. T., Electrochemical Reduction of Superoxide Ion and Oxidation of Hydroxide Ion in Dimethyl Sulfoxide. Anal. Chem. 1968, 40 (1), 83-86.
[2.32] Muller, E.; Hyne, J. B., Hydrogen Bonding in Sulfanes. Can. J. Chem. 1968, 46 (22), 3587-3590.
[2.33] Huo, H.; Chen, Y.; Zhao, N.; Lin, X.; Luo, J.; Yang, X.; Liu, Y.; Guo, X.; Sun, X., In-Situ Formed Li₂CO₃-Free Garnet/Li Interface by Rapid Acid Treatment for Dendrite-Free Solid-State Batteries. Nano Energy 2019, 61, 119-125.
[2.34] Cheng, L.; Wu, C. H.; Jarry, A.; Chen, W.; Ye, Y.; Zhu, J.; Kostecki, R.; Persson, K.; Guo, J.; Salmeron, M.; Chen, G.; Doeff, M., Interrelationships among Grain Size, Surface Composition, Air Stability, and Interfacial Resistance of Al-Substituted Li₇La₃Zr₂O₁₂ Solid Electrolytes. ACS Appl. Mater. Interfaces 2015, 7 (32), 17649-17655.
[2.35] Ruan, Y.; Lu, Y.; Huang, X.; Su, J.; Sun, C.; Jin, J.; Wen, Z., Acid Induced Conversion towards a Robust and Lithiophilic Interface for Li—Li₇La₃Zr₂O₁₂ Solid-State Batteries. J. Mater. Chem. A 2019, 7 (24), 14565-14574.
[2.36] Tang, J.; Niu, Y.; Zhou, Y.; Chen, S.; Yang, Y.; Huang, X.; Tian, B., H₃PO₄-Induced Nano-Li₃PO₄ Pre-reduction Layer to Address Instability Between Nb-doped Li₇La₃Zr₂O₁₂ Electrolyte and Metallic Li Anode. ACS Appl. Mater. Interfaces 2023, 15 (4), 5345-5356.
[2.37] Bates, J. B.; Dudney, N. J.; Gruzalski, G. R.; Zuhr, R. A.; Choudhury, A.; Luck, C. F.; Robertson, J. D., Electrical Properties of Amorphous Lithium Electrolyte Thin Films. Solid State Ionics 1992, 53, 647-654.
[2.38] Ohnishi, T.; Takada, K., Sputter-Deposited Amorphous Li₃PO₄ Solid Electrolyte Films. ACS Omega 2022, 7 (24), 21199-21206.
[2.39] Vasquez, R. P., X-Ray Photoemission Measurements of La₁₋ₓCaₓCoO₃ (X=0, 0.5). Phys. Rev. B 1996, 54 (21), 14938.
[2.40] Zhang, L.; Liu, Y.; Wang, Y.; Li, X.; Wang, Y., Investigation of Phosphate Removal Mechanisms by a Lanthanum Hydroxide Adsorbent Using P-XRD FTIR and XPS. Appl. Surf. Sci. 2021, 557, No. 149838.
[2.41] Shi, C.; Hamann, T.; Takeuchi, S.; Alexander, G. V.; Nolan, A. M.; Limpert, M.; Fu, Z.; O'Neill, J.; Godbey, G.; Dura, J. A.; Wachsman, E., 3D Asymmetric Bilayer Garnet-Hybridized High-Energy-Density Lithium-Sulfur Batteries. ACS Appl. Mater. Interfaces 2023, 15 (1), 751-760.
[2.42] Qu, H.; Ju, J.; Chen, B.; Xue, N.; Du, H.; Han, X.; Zhang, J.; Xu, G.; Yu, Z.; Wang, X.; Cui, G., Inorganic Separators Enable Significantly Suppressed polysulfide Shuttling in High-Performance Lithium-Sulfur Batteries. J. Mater. Chem. A 2018, 6 (46), 23720-23729.

The citation of any document is not to be construed as an admission that it is prior art with respect to the present invention.

Thus, the invention provides hybrid electrolytes and methods for stabilizing an electron pair donor liquid electrolyte solvent and a solid state electrolyte in a lithium-sulfur battery.

In light of the principles and example embodiments described and illustrated herein, it will be recognized that the example embodiments can be modified in arrangement and detail without departing from such principles. Also, the foregoing discussion has focused on particular embodiments, but other configurations are also contemplated. In particular, even though expressions such as “in one embodiment”, “in another embodiment”, “in some embodiments”, or the like are used herein, these phrases are meant to generally reference embodiment possibilities, and are not intended to limit the invention to particular embodiment configurations. As used herein, these terms may reference the same or different embodiments that are combinable into other embodiments. As a rule, any embodiment referenced herein is freely combinable with any one or more of the other embodiments referenced herein, and any number of features of different embodiments are combinable with one another, unless indicated otherwise.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein. Various features and advantages of the invention are set forth in the following claims.

1. A hybrid electrolyte for an electrochemical device, the hybrid electrolyte comprising:
(i) a first electrolyte having a first surface and an opposed second surface, wherein the first electrolyte comprises a solid state electrolyte material comprising an oxide, wherein the first surface is an acid-treated surface; and
(ii) a second electrolyte comprising a liquid electrolyte, wherein the liquid electrolyte comprises an alkali metal salt and a solvent selected from the group consisting of electron pair donor solvents, and solvent mixtures including at least one electron pair donor solvent and at least one glyme solvent.

2. The hybrid electrolyte of claim 1 wherein:
the solvent comprises an electron pair donor solvent having a donor number (DN) greater than 15 kcal/mol.

3. (canceled)

4. (canceled)

5. The hybrid electrolyte of claim 1 wherein:
the solvent comprises N,N-dimethylacetamide (DMA).

6. The hybrid electrolyte of claim 1 wherein:
the solvent comprises a solvent mixture including at least one electron pair donor solvent and at least one glyme solvent.

7. The hybrid electrolyte of claim 1 wherein:
the solvent comprises a solvent mixture including 1,3-dioxolane (DOL) and 1,2-dimethoxyethane (DME).

8. The hybrid electrolyte of claim 1 wherein:
the alkali metal salt is selected from the group consisting of lithium (halosulfonyl)imides, lithium (haloalkanesulfonyl)imides, lithium (halosulfonyl haloalkanesulfonyl)imides, and mixtures thereof.

9. The hybrid electrolyte of claim 1 wherein:
the alkali metal salt is selected from the group consisting of LiBF₄, LiClO₄, LiCF₃SO₃ (LiTf), lithium bis(fluorosulfonyl)imide (LiFSI), lithium bis(trifluoromethanesulfonyl)imide (LiTFSI), lithium (fluorosulfonyl trifluoromethanesulfonyl)imide (LiFTFSI), lithium bis(pentafluoroethanesulfonyl)imide (LiBETI), and mixtures thereof.

10. (canceled)

11. The hybrid electrolyte of claim 1 wherein:
the second electrolyte contacts the first surface of the first electrolyte.

12. The hybrid electrolyte of claim 11 wherein:
the second electrolyte is impregnated in a porous separator layer.

13. (canceled)

14. (canceled)

15. (canceled)

16. The hybrid electrolyte of claim 1 wherein:
the solid state electrolyte material is densified through conventional sintering or hot pressed.

17. The hybrid electrolyte of claim 1 wherein:
the first surface of the first electrolyte is acid-treated using a mineral acid to remove surface impurities.

18. (canceled)

19. (canceled)

20. (canceled)

21. The hybrid electrolyte of claim 1 wherein:
the solid state electrolyte material has a garnet phase.

22. The hybrid electrolyte of claim 1 wherein:
an interfacial resistance of an interface of the first electrolyte and the second electrolyte is 100 Ωcm² or less.

23. (canceled)

24. The hybrid electrolyte of claim 1 wherein:
the solid state electrolyte material has the formula LiᵤReᵥM_{w}AₓO_{y}, wherein Re can be any combination of elements with a nominal valance of +3 including La, Nd, Pr, Pm, Sm, Sc, Eu, Gd, Tb, Dy, Y, Ho, Er, Tm, Yb, and Lu;
M can be any combination of metals with a nominal valance of +3, +4, +5 or +6 including Zr, Ta, Nb, Sb, W, Hf, Sₙ, Ti, V, Bi, Ge, and Si;
A can be any combination of dopant atoms with nominal valance of +1, +2, +3 or +4 including H, Na, K, Rb, Cs, Ba, Sr, Ca, Mg, Fe, Co, Ni, Cu, Zn, Ga, Al, B, and Mn;
u can vary from 3-7.5;
v can vary from 0-3;
w can vary from 0-2;
x can vary from 0-2; and
y can vary from 11-12.5.

25. The hybrid electrolyte of claim 24 wherein:
the first surface of the first electrolyte is acid-treated using H₃PO₄.

26. (canceled)

27. (canceled)

28. The hybrid electrolyte of claim 24 wherein:
the first surface of the first electrolyte includes a phosphorylated layer.

29. The hybrid electrolyte of claim 28 wherein:
the phosphorylated layer has a thickness in a range of 1-30 nanometers.

30. (canceled)

31. (canceled)

32. An electrochemical device comprising:
the hybrid electrolyte of claim 1;
a cathode facing the first surface of the first electrolyte of the hybrid electrolyte; and
an anode contacting the second surface of the first electrolyte of the hybrid electrolyte, wherein the anode comprises lithium metal.

33. The electrochemical device of claim 32 wherein:
the cathode comprises a cathode active material selected from sulfur containing materials.

34. (canceled)

35. (canceled)

36. (canceled)

37. (canceled)

38. (canceled)

39. (canceled)

40. (canceled)

41. (canceled)

42. A method for stabilizing an electron pair donor liquid electrolyte solvent and a solid state doped or undoped LLZO electrolyte having a first surface and an opposed second surface in a lithium-sulfur battery having a sulfur-containing cathode facing the first surface of the LLZO electrolyte and a lithium metal anode contacting the second surface of the LLZO electrolyte, the method comprising:
treating the first surface of the solid state doped or undoped LLZO electrolyte with an acid before contacting the first surface of the solid state doped or undoped LLZO electrolyte with a liquid electrolyte including a lithium metal salt and an electron pair donor liquid electrolyte solvent.

43. (canceled)

44. (canceled)

45. (canceled)

46. (canceled)

47. (canceled)

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)

63. (canceled)
